(19) United States
(12) Patent Application Publication
(10) Pub. No.: US 2026/0100395 A1
(43) Pub. Date: Apr. 9, 2026

(54) INSPECTION DURING THE MANUFACTURE OF MODULES OR PRECURSORS OF MODULES

(71) Applicant: MB Automation GmbH & Co. KG, Roding (DE)

(72) Inventors: Ondrej Vasko, Schwandorf (DE); Christina Breu, Chamerau (DE)

(21) Appl. No.: 19/113,025

(22) PCT Filed: Sep. 27, 2023
(86) PCT No.: PCT/EP2023/076662

§ 371 Date: Mar. 19, 2025

(30) Foreign Application Priority Data
Sep. 27, 2022 (DE) 10 2022 124 784.8

(51) Int. Cl. H01M 10/04; G01N 21/84; G01N 21/88; G01N 35/00; H01M 8/2404

(52) U.S. Cl. CPC H01M 10/0404; G01N 21/8422; G01N 21/8806; G01N 35/0099; H01M 8/2404; G01N 2021/8416; G01N 2021/8438; G01N 2021/8822; G01N 2201/11

(57) ABSTRACT

An inspection device comprises a layer conveyor which has a pickup and a drive in order to pick up a respective individual anode or cathode layer from a transfer location and bring it to a delivery location. A stacking table picks up the anode or cathode layer from the pickup at the delivery location to form a layer stack. The layer conveyor delivers an anode or cathode layer from its pickup to the stacking table at the delivery location. An image sensor is directed towards an area encompassing an upper edge of the layer stack located on the stacking table, which comprises a connection tab of the anode or cathode layer located at the top of the layer stack and performs an image feed before or after the anode or cathode layer is deposited on the stacking table.

### CROSS-REFERENCE TO RELATED APPLICATIONS

This application is a National Stage application of International Application No. PCT/EP2023/076662 filed Sep. 27, 2023, which claims priority to German Patent Application Serial No. DE 102022124784.8 filed Sep. 27, 2022.

### BACKGROUND

### Field

Disclosed herein is an inspection during the manufacture of modules or precursors of modules. These modules or their precursors can be, for example, layer arrangements containing layer material, arrangements for fuel or battery cells, or parts for their manufacture. The layer material can comprise electrode layers which are formed as anode or cathode layers. The inspection is disclosed as a method and as an apparatus. Details are defined in the claims. The description also contains relevant information on the structure and mode of operation of the inspection and on device and process variants.

### Discussion of the Related Art

WO 2021 171 946 A1 relates to a stacking table on which laminate stacks of release films and electrode layer are stacked. A transport unit is used to transport the release films and electrode layer and to place them on the stacking table. The above testing device checks the position of the electrode layer in the laminate stacks released by the transport unit.

JP 2014 078464 A relates to a laminating machine for producing a laminated body of a rectangular film as a positive electrode, a rectangular film as a negative electrode, which are alternately laminated via a rectangular separating film.

WO 2021 171 946 A1 relates to a testing device for testing the position of the electrode layer in a laminate, in which a release film and an electrode layer are bonded by an adhesive, from the release film side. An infrared emitter irradiates the laminate with infrared light from the release film side. An infrared light-sensitive camera records the infrared light transmitted through the release film and reflected by the electrode layer. A detection unit records the position of the electrode layer based on the image recorded by the camera.

WO 2020 130 184 A1 describes the production of a cell stack of a secondary battery. A stacking table can be moved back and forth. A separator feed unit is positioned on the stacking table and feeds a separator to the stacking table. A first multiple head is provided on one side of the stacking table and stacks one layer after the other by placing the electrode layers on the stacking table, which is moved to one side. A second multiple head is provided on the other side of the laminating table and stacks the electrode layers on the stacking table moved to the other side.

Based thereon, a cost-effective and robust arrangement of a stacking unit and a process for stacking layer material with high processing speed is to be provided in order to manufacture modules or precursors of modules, for example fuel or battery cells containing layer material, with high precision.

### SUMMARY

To solve this problem, inspection devices and inspection methods are proposed in accordance with the independent device and method claims.

The inspection solutions presented here can be integrated into a handling (device or process) in which the stacking table moves back and forth and is fed with one anode or cathode at each end position by one of two layer conveyors to form the electrode stack. The back-and-forth movement of the stacking table between the first and second delivery locations limits the number of anode or cathode layers to be deposited per time unit. A solution presented here of radially retracting the respective pickup(s) of one layer turner when approaching the pickup(s) of the other layer turner, especially in the space between the two layer turners, allows a smaller distance between the first and second delivery location than with a circular trajectory of the pickups of both layer turners, which must not touch each other. This allows the length of the travel path of the stacking table between the two delivery locations to be reduced. This is particularly relevant after the pickups have deposited the anode or cathode layers on the stacking table (6 o'clock position in FIG. 1) and the empty pickups enter the space between the two layer turners. Without this radial retraction of the pickups, their trajectories would be significantly larger, which would result in an increased distance between the first and second delivery locations. This also enables a more compact design of the entire device. Overall, in a variant, the pickups of the two layer turners each move along an approximated, upright ellipse whose (vertical) main axes extend from the center of the respective transfer location to the center of the respective delivery location and whose (horizontal) secondary axes do not touch each other. Guiding the pickups along these approximately elliptical paths avoids a collision of the pickups when turning from the delivery location back to the transfer location, although the two layer turners are arranged close to each other in order to keep the path of the stacking table from one layer turner to the other as short as possible.

In a variant of the device, the first and second layer turners are provided and set up to extend the pickups by means of their respective second drive when the pickups approach the respective first or second transfer location and/or the first or second delivery location. To pick up the anode or cathode layers at the respective transfer locations (12 o'clock or 6 o'clock position in FIG. 1), the pickups of the two layer turners can be extended radially. The radial movement of the pickups begins before the pickups reach the 6 or 12 o'clock position and not only when they reach this position.

This increases the location accuracy of the pickup of the anode or cathode layers from the two conveyors at the respective transfer locations. This allows a higher number of anode or cathode layers per time unit to be placed on the stacking table without impairing the accuracy of the electrode stack build-up.

In a variant of the device, an endless separator is fed from above into the space between the two layer turners, which is folded into a Z-shape on the stacking table. The stacking table constantly moves horizontally back and forth between the two delivery locations, so that for a stack of electrodes, starting with the separator and then alternately the anode and cathode layers, always separated by the folded separator, are deposited alternately by the two layer turners on the stacking table.

In a variant of the device, the first conveyor and the second conveyor are arranged adjacent to and at a distance from one another. In a variant of the device, the first conveyor and/or the second conveyor are designed as belt conveyors, the respective undersides of which face the first or second layer turners in order to convey the individual anode layers or the individual cathode layers on their undersides to the first or second transfer location.

In a variant of the device, the first conveyor and/or the second conveyor each have a controlled under/over-pressure conveyor belt. They are provided and set up to pick up the individual anode layers or the individual cathode layers by means of controlled pneumatic negative pressure and to hold them during conveying to the first or the second transfer location. In a variant of the device, the individual anode layers or the individual cathode layers are released to the first or second layer turners at the first or second transfer location by means of a controlled pneumatic overpressure, for example in the form of a short blast.

In a variant of the device, the first and/or the second layer turner each have several pickups for picking up the individual anode or cathode layers. The pickups are provided and set up to rotate past the respective transfer location and the respective delivery location in a continuous or clocked manner. The pickups of the first and/or second layer turner can pick up or release the respective individual anode or cathode layer.

The angle of rotation of the first and/or second layer turner is, for example, approximately 180°. However, it can also be less (e.g. 90°) or more (e.g. 270°). The angle of rotation describes the degree to which a layer is pivoted or turned by the layer conveyor between the transfer location and the delivery location. Picking up a layer from the conveyor using the layer turner, turning it and then placing it on the stacking table turns the layer. This means that the free upper side of the layer lying off the conveyor before it is picked up by the pickups is the same free upper side of the layer after it has been placed on the stacking table, but with the orientation turned by the angle of rotation (for example 180°). The rotation of the first or second layer turners and its pickup devices takes place around their respective centers of rotation/axes of rotation.

In a variant of the device, the first and the second layer turners have an essentially matching structure, matching function and/or matching dimensions. In a variant of the device, the first and the second layer turners are provided and arranged to rotate clockwise and counterclockwise, respectively, by means of their respective first drive such that the individual anode or cathode layers pass from their transfer location to their delivery location while avoiding a space between the first and the second layer turner. In other words, the individual anode or cathode layers are conveyed from their transfer location to their delivery location “around the outside” of the first or second layer turners, and not between the two layer turners.

In a variant of the device, the first and second transfer locations between the first conveyor or the second conveyor and the first or second layer turners each have a first center, and the first and second delivery locations each have a second center between the first or second layer turners and the stacking table. In a variant of the device, these respective first and second centers are located on a straight line that essentially at least approximately intersects a respective center of rotation of the first conveyor or the second conveyor.

In a variant of the device, the stacking table has a tray for the individual anode and cathode layers. In a variant of the device, the stacking table has a single-axis or multi-axis positioning device, which is provided and designed to move the tray along or around the respective axis(es) in order to align it with the first or second delivery location. This allows precise stacking of the layers on the tray, which enables reliable production without large losses of incorrectly produced stacks of electrodes.

In a variant of the device, the stacking table has at least one first and at least one second clamping finger, which are provided and designed to alternately or simultaneously engage or disengage with the uppermost of the anode and cathode layers and/or to press the uppermost of the anode and cathode layers against the electrode stack on the tray. In a variant, the tray/stacking table can be rotated about a z-axis (vertical axis) using the clamping fingers. In a variant, the tray/stacking table can be positioned in the x and/or y direction using the clamping fingers.

In a variant of the device, the first and second layer turners are provided and arranged to pick up the individual anode layers and the individual cathode layers by means of a controlled pneumatic negative pressure and to hold them during turning to the first and second delivery location, respectively. In addition or instead, the individual anode layers and the individual cathode layers are to be delivered to the first or second delivery location by means of a controlled pneumatic overpressure in order to stack the layers on the tray.

In a variant of the device, the first and the second layer turners each have a rotatable positive/negative pressure distributor, which is provided and set up to feed the pickups with the controlled pneumatic negative pressure and/or positive pressure. In a variant of the device, the first and second layer turners are provided and set up to turn only individual anode layers or only individual cathode layers towards the first or second delivery location.

In a variant of the device, each positioning device is provided and set up to lower the deposit during stacking of the individual anode layers and individual cathode layers by a distance which substantially corresponds to a thickness of an individual anode layer or an individual cathode layer.

In a variant of the device, the first drive is designed as a rotary drive, which is intended and set up to turn the pickup of the layer turner. In a variant of the device, the second drive has a rotary drive with an eccentric shaft geared to the transducers in order to radially retract and/or extend the transducer of the respective layer turner. Alternatively, the second drive has a linear drive which is geared to one of the transducers in order to radially retract and/or extend the transducers of the respective layer turner.

A method for the production of modules or precursors of modules, in particular of fuel or battery cells containing layer material, carried out for example with the device described above, comprises the steps, for example in the following sequence: conveying individual anode layers to a first transfer location for transfer to a first layer turner; conveying individual cathode layers to a second transfer location for transfer to a second layer turner; picking up respective individual anode or cathode layers at the respective first or second transfer location by means of corresponding pickups of a respective first or second layer turner; turning the picked up individual anode or cathode layers through a respective angle of rotation to a respective first or second transfer location; turning the picked up individual anode or cathode layers back and forth to a respective first or second transfer location; turning the picked up individual anode or cathode layers through a respective angle of rotation to a respective first or second transfer location; turning the picked up individual anode or cathode layers back and forth to a respective first or second transfer location; turning the picked up individual anode or cathode layers back and forth to a respective first or second transfer location; turning the picked up individual anode or cathode layers back and forth to a respective first or the respective first and second delivery locations; moving a stacking table with a drive back and forth between the first and second delivery locations; delivering the respective individual anode or cathode layer at the first or second delivery location to the stacking table when it is located at the first or second delivery location; and radially retracting the pickup of the first and/or second layer turner when it approaches the pickup of the other layer turner.

This approach of the pickup of one layer turner to the pickup of the other layer turner is particularly relevant in the space between the two layer turners when the pickup approaches a pickup of the other layer turner on the way from its delivery location to its transfer location or from its transfer location to its delivery location.

A first variant of the inspection device for layer material, in particular for the production of fuel or battery cells, has a first layer conveyor and a first drive and is provided and set up to pick up a respective individual anode or cathode layer by means of the at least one pickup from a first transfer location and to bring it to a first delivery location. In this variant, the first layer conveyor is provided and arranged to deliver a respective individual anode or cathode layer from its pickup to the stacking table at the first delivery location when the respective at least one pickup is located at the first delivery location. In this variant, at least one drive is provided in order to align the pickup and the stacking table relative to one another as a function of a signaling based on processing of the first and/or second image feed. In this variant, a first image sensor between the first transfer location and the first delivery location is aligned with a first region of the first layer conveyor and is provided and set up for a first image acquisition when the at least one pickup of the first layer conveyor passes the first image sensor. In this variant, alternatively or cumulatively, a second image sensor between the first transfer location and the first delivery location is aligned with a second region of the first layer conveyor and is provided and set up for a second image acquisition when the at least one pickup of the first layer conveyor passes the second image sensor. In this variant, a stacking table is provided and arranged to receive the respective individual anode or cathode layer at the first delivery location to form a layer stack.

In a variant, the first layer conveyor comprises a layer turner which is provided and set up to pick up a respective individual anode or cathode layer by means of the at least one pickup from the first transfer location and to rotate it through a respective rotation angle to a first delivery location.

In a variant, the first layer conveyor comprises a layer gripper, which is provided and set up to pick up a respective individual anode or cathode layer from the first transfer location by means of a pickup, for example in the form of a suction or gripping tool, and bring it to the first delivery location.

In one embodiment, a second layer conveyor is provided and arranged to receive a single cathode or anode layer and transfer it to a second delivery location. In a variant, a first image sensor is aligned with a first region of the second layer conveyor between the second transfer location and the second delivery location and is provided and arranged for a first image acquisition when the second layer conveyor passes the first image sensor. Alternatively or cumulatively, in a variant, a second image sensor between the second transfer location and the second delivery location is aligned with a second region of the second layer conveyor and is provided and set up for a second image acquisition when the second layer conveyor passes the second image sensor.

In a variant, the second layer conveyor comprises a layer turner which is provided and arranged to pick up a respective individual anode or cathode layer by means of the at least one pickup from the second transfer location and to rotate it through a respective rotation angle to a second delivery location.

In a variant, the second layer conveyor comprises a layer gripper, which is provided and set up to pick up a respective individual anode or cathode layer from the second transfer location by means of a pickup, for example in the form of a suction or gripping tool, and bring it to the second delivery location.

In a variant, a drive is assigned to the stacking table, which is provided and set up to move the stacking table back and forth between the first and second delivery locations. In a variant, the first and second layer conveyors are each provided and arranged to deliver a single anode or cathode layer to the stacking table at the first and second delivery locations, respectively. In a variant, at least one drive is provided in order to align the respective layer conveyor and/or the respective at least one layer turner or layer gripper relative to the stacking table as a function of a signaling based on processing of the first and/or second image feed in a control system. This drive can be designed as an additional drive in the Y-direction and/or as a rotary drive about the z-axis in theta for the stacker.

In a variant, the first region and the second region of the at least one pickup of the layer turner are corner regions of the at least one pickup of the layer turner that are diagonal to one another. In a variant, the first corner region and the second corner region of the at least one transducer of the layer turner are provided and arranged to receive a first corner or second corner of the individual anode or cathode layer. In a variant, the first and/or the second image sensor between the transfer location and the delivery location are aligned with the first or second corner region of the pickup at an angle of about 30° to about 150°, or at an angle of about 60° to about 120°, at an angle of about 80° to about 100°, or at an angle of about 90° to the surface of the pickup in the respective region, at the time of the first or second image acquisition.

In a variant, the first and/or the second image sensor are adjustable along their optical axes for focusing and/or are movable during operation. In a variant, a white light source assigned to the first and/or the second image sensor is intended and set up to illuminate the anode/cathode position for an image acquisition by the first and/or the second image sensor. In a variant, at least one optically effective element is assigned to the first and/or the second image sensor; wherein the optically effective element is intended and set up to detect the position and/or orientation of the anode/cathode layer at one or more locations or regions before or upon its arrival at the delivery location or on the way to the delivery location; and/or wherein the at least one optically active element is a lens or lens arrangement, a mirror or a mirror arrangement, a prism or a prism arrangement, a light guide arrangement, an area light, a coaxial ring light, a dark-field light, or combinations thereof.

In a variant, the control unit is intended and set up to determine correction values from the image feed or the image feeds from the position and/or orientation of the anode/cathode layer before it is picked up by the stacking table, the position and/or orientation of the stacking table, and/or the position and/or orientation of the picked up individual anode/cathode layer relative to the stacking table during the turning of the anode/cathode layer to the stacking table. In a variant, the control unit is intended and set up to take these correction values into account in positioning commands to the layer turner, the pickup and/or the stacking table when aligning the stacking table with the transported anode/cathode layer relative to the deposit location. In a variant, the control unit is intended and set up to take into account these correction values for the alignment and the location of the stacking table when picking up the anode/cathode layer in positioning commands to the layer turner, the pickup and/or the stacking table in such a way that the stacking table picks up the respective anode/cathode layer in a central zero position and/or aligned with the electrode stack located at the delivery location. In a variant, the control unit is intended and set up to determine the alignment and the location of the stacking table during or before picking up the anode/cathode layer by checking the position of the incoming anode/cathode layer in the image inserts immediately before the delivery location.

In a variant, the sensor can be moved radially relative to its axis of rotation, and the first image sensor and/or the second image sensor is set up for a first or second image acquisition when the sensor moves radially outwards or inwards.

A variant of an inspection method in the manufacture of modules or precursors of modules comprises the steps of: picking up an anode/cathode layer from a transfer location; bringing the anode/cathode layer from the transfer location to a delivery location; detecting the position and/or orientation of the anode/cathode layer at the layer turner by means of a first image sensor between the transfer location and the delivery location, the first image sensor being aligned with a first region of the layer turner and being provided and set up for a first image acquisition when the anode/cathode layer at the layer turner passes the first image sensor.

In a variant of the inspection method, the position and/or orientation of the anode/cathode layer on the layer turner is detected by means of a second image sensor between the transfer location and the delivery location, the second image sensor being aligned with a second area of the layer turner and being provided and set up for a second image acquisition when the at least one pickup of the layer turner passes the second image sensor. In a variant of the inspection method, the transducer and the stacking table are aligned relative to one another as a function of a signaling based on processing of the first and/or second image feed. In a variant of the inspection method, the respective individual anode or cathode layer is released from the respective at least one pickup at the release location onto the stacking table to form a layer stack when the respective at least one pickup is located at the release location

In a variant of the inspection method, the first and/or the second image sensor detect the position and/or orientation of the anode/cathode layer in x, y, z, and/or theta in a perpendicular, ± approximately 25°, top view (relative to the surface of the anode/cathode layer) of the anode/cathode layer when the at least one pickup of the layer turner passes the respective image sensor. In a variant of the inspection method, a light source associated with the first and/or the second image sensor illuminates the anode/cathode position for an image acquisition by the first and/or the second image sensor. In a variant of the inspection method, the first and/or the second image sensor completely captures the anode/cathode position with an image feed in order to capture its position and/or orientation in x, y, z, and/or theta. In a variant of the inspection method, the first and/or the second image sensor detect a region, at least one corner region, two diagonal corner regions, and/or at least one corner region and at least a section of an edge of the anode/cathode layer relative to a respective defined image sensor zero location with a single image acquisition in order to detect the position and/or orientation in x, y, z, and/or theta of the anode/cathode layer. In a variant of the inspection method, the first and/or the second image sensor are designed as a matrix camera or as a line scan camera, which detect the position and/or orientation in x, y, z, and/or theta of the anode/cathode layer before or on arrival at the delivery location or on the way to the delivery location

In a variant of the inspection method, correction values are determined from the position and/or orientation in x, y, z, and/or theta of the anode/cathode layer after it has been picked up by the at least one pickup of the layer turner, the position and/or orientation in x, y, z, and/or theta of the stacking table, and/or the position and/or orientation in x, y, z, and/or theta of the picked up individual anode/cathode layer during a turning of the anode/cathode layer relative to the stacking table. In a variant of the inspection method, these correction values are taken into account during alignment in x, y, z, and/or theta of the pickup of the layer turner with the transported anode/cathode layer relative to the stacking table at the delivery location. In a variant of the inspection method, these correction values in x, y, z, and/or theta are taken into account when aligning the pickup of the layer turner in such a way that the anode/cathode layer is picked up by the stacking table in a centered zero position and/or aligned.

With the first type of inspection proposed here during cell production with the first and second image sensors (cameras) using the first and second image sensors, the electrode layers are stacked on top of each other as precisely as possible. In this way, the highest possible efficiency of the finished fuel or battery cells can be achieved. The less precisely the electrode layers are stacked, the lower the efficiency. The inspection proposed here detects the exact position of the electrode layer (during turning, in other words) immediately before stacking. From this position, a measure for correcting the relative position between the stacking table and the pickup of the layer turner is determined and applied. In this way, the accuracy of the placement of the individual electrode layer on the growing stack is as precise as possible. This procedure avoids production rejects, and higher efficiencies of the finished fuel or battery cells can be achieved.

In a variant, the first and second corner areas of the inspected electrode or layer turner are different. In a variant, a stacking table is provided and set up to receive the respective individual anode or cathode layer at the first delivery location to form a layer stack.

In a variant, the first corner region and the second corner region of the first layer turner are regions of the first layer turner lying diagonally to one another. In a variant, the first corner region and the second corner region are two (approximately equally sized) surface regions of the at least one pickup of the first layer turner when this pickup is located on the path between the first transfer location and the first delivery location.

In a variant, the first corner region and the second corner region of the at least one pickup of the first layer conveyor are provided and arranged to pick up a first corner or second corner of the individual anode or cathode layer.

In one embodiment, the first and/or second image sensor between the first/second transfer location and the first/second delivery location are aligned with the first and/or second corner region of the first/second layer conveyor at an angle of about 25° to about 150°, or at an angle of about 60° to about 120°, or at an angle of about 80° to about 100°, or at an angle of about 90° (relative to the surface of the anode/cathode layer or the first/second pickup) at the time of the first and/or second image feed.

In variants of the inspection, the first and/or the second camera record the position and/or orientation of the anode/cathode layer on the respective sensor (in relation to the surface of the anode/cathode layer or of the first/second sensor) in a vertical, ± approximately 25° to approximately ±30°, top view of the anode/cathode layer when it passes the respective image sensor. In variants of the inspection, the first and/or the second image sensor can be adjusted along their optical axes for focusing and/or can be moved during operation.

In variants of the inspection, a white light source associated with the first and/or second image sensor illuminates the anode/cathode position for an image acquisition by the first and/or second image sensor. In variants of the inspection, the first and/or the second camera completely capture the anode/cathode position with a (single) image acquisition in order to capture its position and/or orientation.

In variants of the inspection method, the first and/or the second camera capture an area, at least one corner area, two diagonal corner areas, and/or at least one corner area and at least a portion of an edge of the anode/cathode layer with a single image acquisition in order to detect the position and/or orientation of the anode/cathode layer.

In variants of the inspection, the first and/or second camera is designed as a matrix or line scan camera, which records the position and/or orientation of the anode/cathode position during turning towards the stacking table.

In variants of the inspection, correction values are determined from the position and/or orientation of the anode/cathode layer on the pickup during the turning of the anode/cathode layer towards the delivery location on the stacking table. These correction values are taken into account in variants of the inspection when aligning the stacking table relative to the pickup with the transported anode/cathode layer at the delivery location.

In variants of the inspection, these correction values are taken into account when aligning the stacking table for picking up the anode/cathode layer by the stacking table in such a way that the anode/cathode layer is picked up by the stacking table in a centered zero position and/or aligned.

During the inspection, in a variant, the calculated correction values can be used to position the stacking device relative to the anode/cathode layer before/as it is deposited on the stacking table so that the anode/cathode layer is picked up by the stacking table in a zero position. For this purpose, the stacking table can be corrected in its position and/or orientation to the anode/cathode layer/to the layer conveyor at the delivery location. Similarly, after being picked up during transportation, the stacking table can be positioned according to the correction values from the image feed in such a way that the anode/cathode layer is deposited by the stacking table on the stack of electrodes located there when it is deposited at the delivery location, so that the anode/cathode layer fits and is deposited with minimal or no further correction movement. This can be done very quickly and with high precision. A device described below, for example, is suitable for inspection.

In variants of the inspection, a (white) light source assigned to the camera(s) is intended and set up to illuminate the anode/cathode position for image acquisition by the respective camera.

In variants of the inspection device, at least one optically effective element is connected upstream of one or all of the camera(s) and is intended and set up to detect the position and/or orientation of the anode/cathode position at one or more locations or areas before it is picked up by the pickup or when it arrives at the delivery location or on the way to the delivery location. In variants of the device, the at least one optically active element is a lens or lens arrangement, a mirror or mirror arrangement, a prism or prism arrangement, a light guide arrangement, an area light, a coaxial ring light, a dark-field light, or combinations thereof. In variants of the inspection, a control unit is intended and set up to determine correction values from the image acquisition and/or data from the acquisition device and/or the first and/or the second camera from the position and/or orientation of the anode/cathode layer before it is picked up by the stacking table, the position and/or orientation of the stacking table, and/or the position and/or orientation of the picked up individual anode/cathode layer relative to the stacking table during a turning of the anode/cathode layer to the stacking table.

In variants of the inspection, the control unit is intended and set up to take these correction values into account when aligning the stacking table with the transported anode/cathode layer relative to the delivery location in positioning commands to the layer turner and/or its pickup and/or the stacking table. In variants of the inspection, a control unit is intended and set up to take into account these correction values for the alignment and location of the stacking table when picking up the anode/cathode layer in positioning commands such that the stacking table picks up the respective anode/cathode layer in a central zero position and/or aligned with the electrode stack located at the delivery location.

By checking the position of the incoming anode/cathode layer immediately before the delivery location, the alignment and location of the stacking table can be precisely determined during or before picking up the anode/cathode layer. This allows a precisely determined, corrected pickup of the anode/cathode layer by the stacking table to form a stack of electrode layers that is exactly aligned in the vertical extension and the angular position around the vertical axis.

In a second variant, an inspection device for layer material, in particular for the production of fuel or battery cells, comprises a first layer conveyor which has at least one pickup and a first drive and is provided and set up to pick up a respective individual anode or cathode layer by means of the at least one pickup from a first transfer location and to bring it to a first delivery location. In a variant, a stacking table is provided and arranged to receive the respective individual anode or cathode layer from the pickup at the first delivery location to form a layer stack. In a variant, the first layer conveyor is provided and set up to deliver a single anode or cathode layer from its pickup to the stacking table at the first delivery location when the pickup is located at the first delivery location. In a variant, a third image sensor is directed towards a region comprising an upper edge of a layer stack located on the stacking table in a side view of the layer stack, which region comprises a connection tab of an anode or cathode layer located at the top of the layer stack, and is provided and set up for a third image acquisition before and/or after the anode or cathode layer is deposited on the stacking table. In a variant, a controller is provided and set up to indicate the (un)usability of the layer stack as a function of a signaling based on processing of the third image feed. The stack can then be (automatically) removed.

In a variant, the layer conveyor comprises a layer turner, which is provided and set up to pick up a respective individual anode or cathode layer from the first transfer location by means of the at least one pickup and to rotate it through a respective rotation angle to a first delivery location.

In a further variant, the layer conveyor comprises a layer gripper, which is provided and set up to pick up a respective individual anode or cathode layer from the first transfer location by means of the one pickup, for example in the form of a suction or gripping tool, and to bring it to the first delivery location.

In a further variant, the inspection device comprises a second layer conveyor, which is intended and set up to pick up a single cathode or anode layer and bring it to a second delivery location. In a variant, the stacking table is associated with a drive which is provided and arranged to move the stacking table back and forth between the first and second delivery locations. In a variant, the first and second layer conveyors are each provided and arranged to deliver a single anode or cathode layer to the stacking table at the first and second delivery locations, respectively. In a variant, at least one drive is provided in order to align the respective layer conveyor and/or a respective at least one layer turner or layer gripper relative to the stacking table as a function of a signaling based on processing of the first and/or second image feed in a control system.

In a variant, the second layer conveyor comprises a layer turner, which is provided and set up to pick up a respective individual anode or cathode layer by means of the at least one pickup from the second transfer location and to rotate it through a respective rotation angle to a second delivery location.

In a variant, the second layer conveyor comprises a layer gripper, which is provided and set up to pick up a respective individual anode or cathode layer from the second transfer location by means of a pickup, for example in the form of a suction or gripping tool, and to bring it to the second delivery location.

In a variant, a first third region and a second third region of the layer stack each comprise a connection tab of the respective uppermost anode or cathode layer on the stacking table at the first and second delivery locations, respectively. In a variant, one or two third image sensors are arranged on a first side of the inspection device, and one or two third image sensors are arranged on a second side of the inspection device. In a variant, one or more third image sensors are arranged in a fixed position relative to the movable stacking table. In a variant, one or more third image sensors are connected to the stacking table in order to be movable therewith.

In a variant of the inspection device, the at least one third image sensor is adjustable along its optical axis for focusing and/or can be moved during operation. In a variant, a light source associated with the third image sensor is intended and set up to illuminate the anode/cathode position for an image acquisition by the third image sensor. In a variant, at least one optically effective element is associated with the at least one third image sensor. In a variant, the optically effective element is intended and set up to make the connection tab of an anode or cathode layer located at the top of the layer stack recognizable in the third image acquisition after the anode or cathode layer has been deposited on the layer stack. In a variant, the at least one optically effective element is a lens or lens arrangement, a mirror or a mirror arrangement, a prism or a prism arrangement, a light guide arrangement, an area light, a coaxial ring illumination, a dark field illumination, a transmitted light illumination, or a combination thereof.

With transmitted light illumination, the light is directed in the opposite direction to the direction of view of the image sensor. The light does not pass through the material of the connection tab, as is the case with a semiconductor chip with IR light, for example.

In a variant of the inspection device, the transmitted light illumination is arranged on the opposite side of the third image sensor beyond the position of the connection tab on the stacking table and is set up to take the connection tab into the light beam path. This means that a lift-off of the connection tab can be detected by processing the third image acquisition, in that the top edge of the connection tab in the image acquisition is not essentially horizontal (<±10° relative to the horizontal or to the optical axis of the respective third image acquisition device), or is oriented flat with the electrode and/or causes an interfering contour.

In a variant of the inspection device, the coaxial ring illumination is arranged on the side of the third image sensor on this side of the position of the terminal tab on the stacking table and is set up to take the terminal tab into the light beam path in order to detect a lift-off of the terminal tab by means of processing of the third image sensor, in which the uppermost edge of the terminal tab is not oriented (<±10° relative to the horizontal or to the optical axis of the respective third image sensor), or is oriented flat with the electrode and/or causes an interfering contour.

A second inspection method in the manufacture of modules or precursors of modules comprises the steps of: picking up an anode/cathode layer at a first transfer location and bringing the anode or cathode layer from the first transfer location to a first delivery location; delivering the respective individual anode or cathode layer at the delivery location onto a stacking table to form a stack of layers; directing a third image sensor onto a region comprising an upper edge of a layer stack located on the stacking table in a side view, wherein the region comprises a connection tab of an anode or cathode layer located uppermost on the layer stack; and wherein a third image acquisition is performed by means of the third image sensor after the anode or cathode layer has been placed on the stack. and indicating a (non-)usability of the layer stack depending on a signaling based on a processing of the third image acquisition.

In a variant, the inspection method further comprises the steps of: setting the at least one third image sensor for focusing along its optical axis; and/or moving the at least one third image sensor for focusing along its optical axis during operation; and/or illuminating the anode/cathode position for a third image acquisition by the at least one third image sensor by means of a light source associated with the at least one third image sensor; and/or assigning at least one optically effective element to the at least one third image sensor; wherein the optically effective element is intended and set up to make the connection tab of an anode or cathode layer located at the top of the layer stack recognizable in the third image acquisition in a side view after the anode or cathode layer has been placed on the layer stack. cathode layer is placed on the layer stack; and/or wherein the at least one optically effective element is a lens or lens arrangement, a mirror or a mirror arrangement, a prism or a prism arrangement, an optical fiber arrangement, an area light, a coaxial ring illumination, a dark field illumination, a transmitted light illumination, or a combination thereof.

In a variant, the inspection method further comprises the following steps: arranging the transmitted light illumination on the opposite side of the at least one third image sensor, beyond the position of the terminal tab on the stacking table, and for this purpose arranging the at least one third image sensor to take the terminal tab into the light beam path; in order to detect, by means of processing of the third image acquisition, a lift-off of the terminal tab in which the uppermost edge of the terminal tab is not oriented (<±10° relative to the horizontal or to the optical axis of the respective third image acquisition device) or is oriented flat with the electrode and/or causes an interfering contour.

In a variant, the inspection method further comprises the steps of: arranging the coaxial ring illumination on the side of the at least one third image sensor, on this side of the position of the terminal tab on the stacking table, and for this purpose setting up the at least one third image sensor to take the terminal tab into the light beam path; recognizing, by means of processing of the third image acquisition, a lift-off of the terminal tab, in that in the third image acquisition the uppermost edge of the terminal tab is not horizontal (<±10° relative to the horizontal or to the optical axis of the respective third image acquisition device), or is oriented flat with the electrode and/or causes an interfering contour.

With the further, second inspection proposed here during cell production with the at least one third image sensor (camera), the alignment of the connection tab of the uppermost electrode layer with the underlying connection tab(s) is also checked to ensure that it is as flat as possible.

This further inspection must be carried out as an alternative or in addition to the first inspection. This is to avoid possible failure or loss of efficiency of the finished fuel or battery cells. When stacking a layer of electrodes, it can also happen that their connection tabs stand up, bulge or bend upwards, creating the risk of them being bent, for example when stacking the next layer of electrodes of the same polarity. If the terminal tabs are not fully connected to each other, the efficiency of the fuel or battery cell will be reduced. If a terminal tab is bent over the separating foil and comes into contact with the counter-electrode layer, this can cause a short circuit in the cell. The inspection proposed here detects the exact orientation of the terminal tabs of each electrode layer immediately after stacking. This position is used to determine and apply a measure to correct the relative position between the stacking table and the pickup of the layer turner. In this way, the accuracy of the placement of the individual electrode layer on the growing stack is as precise as possible in relation to the stack of electrodes already on the stacking table. This means that fewer rejects can be produced and a higher degree of efficiency can be achieved.

A further, third inspection of the cell production comprises the steps, for example in the following sequence: Providing a separated anode/cathode layer; conveying the anode/cathode layer to a delivery location; stacking the conveyed anode/cathode layer at the delivery location on a stacking table; detecting a stack of electrodes grown around the stacked anode/cathode layer at the delivery location in at least one side view of a corner and/or a high edge of the stack of electrodes at the delivery location; and checking the orientation and/or position of the or each stacked anode/cathode layer relative to the rest of the stack of electrodes grown at the delivery location.

This can be achieved with an inspection device for layer material, in particular for the production of fuel or battery cells in a third variant, in which: a first layer conveyor is provided and set up to pick up a respective individual anode or cathode layer and bring it to a first delivery location; a stacking table is provided and set up to pick up the respective individual anode or cathode layer at the first delivery location to form a layer stack; the first layer conveyor is provided and set up to deliver a respective individual anode or cathode layer to the stacking table at the first delivery location; and a fourth image sensor is aligned with a fourth region of the layer stack of anode and cathode layers in a planar side view of the layer stack and is provided and set up for image acquisition after the anode or cathode layer is deposited on the layer stack on the stacking table, wherein the fourth region comprises a corner of an anode or cathode layer located uppermost on the layer stack and/or a high edge of the layer stack; and/or a fifth image sensor is aligned with a fifth region of the layer stack of anode and cathode layers in a planar side view of the layer stack and is provided and set up for image acquisition after the anode or cathode layer on the layer stack is deposited on the stacking table, the fifth region comprising a corner of an anode or cathode layer located uppermost on the layer stack and/or a high edge of the layer stack; the fourth region or the fifth region of the anode or cathode layer being aligned with the fifth region of the layer stack in a planar side view of the layer stack and being provided and set up for image acquisition after the anode or cathode layer on the layer stack is deposited on the stacking table, the fifth region comprising a corner of an anode or cathode layer located uppermost on the layer stack and/or a high edge of the layer stack; the fourth region or the fifth region of the anode or cathode layer in the layer surface comprises regions of the layer stack of anode and cathode layers which are adjacent or diagonal to one another in a respective side view of the layer stack. The inspection device can be set up to indicate a (dis)usability of the layer stack depending on a signaling based on a processing of an image acquisition of the fourth or fifth image sensor.

The fourth and fifth areas are different regions of the layer stack on the stacking table.

In a variant, the layer conveyor comprises a layer turner which is provided and set up to pick up a respective individual anode or cathode layer by means of at least one pickup from the first transfer location and to rotate it through a respective angle of rotation relative to the first delivery location.

In a variant, the layer conveyor comprises a layer gripper, which is provided and set up to pick up a respective individual anode or cathode layer from the first transfer location by means of a pickup, for example in the form of a suction or gripping tool, and to bring it to the first delivery location.

In a variant, the fourth image sensor and/or the fifth image sensor are adjustable along their optical axis for focusing and/or are movable during operation. In a variant, a light source assigned to the fourth image sensor and/or the fifth image sensor is intended and set up to illuminate the anode/cathode position for a fourth image acquisition or a fifth image acquisition by the fourth image sensor or fifth image sensor. In a variant, at least one optically effective element is associated with the fourth image sensor or fifth image sensor. In a variant, the optically effective element is intended and set up to make the corner of the anode or cathode layer located at the top of the layer stack and/or the high edge of the layer stack recognizable in the fourth image sensor or the fifth image sensor after the anode or cathode layer has been deposited on the layer stack. In a variant, the at least one optically effective element is a lens or lens arrangement, a mirror or a mirror arrangement, a prism or a prism arrangement, a light guide arrangement, an area light, a coaxial ring illumination, a dark-field illumination, a transmitted light illumination, or a combination thereof.

In a variant, the transmitted light illumination is arranged on the opposite side of the fourth image sensor or the fifth image sensor, beyond the position of the corner of the anode or cathode layer located at the top of the layer stack and/or the high edge of the layer stack, and is set up to take the corner and/or the high edge into the light beam path. In a variant, a lift-off, displacement or rotation of the anode or cathode layer can be detected by processing the fourth image acquisition or the fifth image acquisition, in that the corner and/or the high edge of the anode or cathode layer located at the top of the layer stack causes an interfering contour in the image acquisition.

In a variant, the coaxial ring illumination is arranged on the side of the fourth image sensor or the fifth image sensor on this side of the position of the corner of the anode or cathode layer located at the top of the layer stack and/or the high edge of the layer stack, and is set up to take the corner and/or the high edge into the light beam path. In a variant, a lift-off, displacement or rotation of the anode or cathode layer can be detected by processing the fourth image acquisition or the fifth image acquisition by causing an interfering contour in the image acquisition of the corner and/or the high edge.

In a variant, a first fourth region and a first fifth region of the layer stack each comprise a corner of a first, essentially horizontally oriented edge of the anode or cathode layer located at the top of the layer stack and/or a high edge of the layer stack on the stacking table, and/or a second fourth region and a second fifth region of the layer stack each comprise a corner of a second edge of the anode or cathode layer located at the top of the layer stack and/or a high edge of the layer stack on the stacking table, and/or a second fourth region and a second fifth region of the layer stack each comprise a corner of a second edge of the anode or cathode layer located uppermost on the layer stack and/or a high edge of the layer stack on the stacking table. In a variant, one or more fourth or fifth image sensors are arranged in a fixed position relative to the movable stacking table. In a variant, one or more fourth or fifth image sensors are connected to the stacking table in order to be movable therewith.

In a variant, a third inspection method in the manufacture of modules or precursors of modules comprises the steps of: picking up an anode/cathode layer by means of at least one pickup from a transfer location; delivering the respective individual anode or cathode layer from the respective at least one pickup at a delivery location onto a stacking table to form a layer stack when the respective at least one pickup is located at the delivery location; directing a fourth image sensor to a fourth region of the layer stack of anode and cathode layers in a planar side view of the layer stack, wherein the fourth region comprises a corner of an anode or cathode layer located on top of the layer stack and/or a high edge of the layer stack; and performing a fourth image acquisition after the anode or cathode layer on the layer stack has been placed on the stacking table; and/or directing a fifth image sensor to a fifth region of the layer stack of anode and cathode layers in a side view of the layer stack, the fifth region comprising a corner of an anode or cathode layer uppermost on the layer stack and/or a high edge of the layer stack; and/or performing a fifth image feed after the anode or cathode layer on the layer stack has been placed on the stacking table; and/or wherein the fourth region or the fifth region of the anode or cathode layer in the layer face comprises adjacent or diagonal regions of the layer stack of anode and cathode layers in a respective side view of the layer stack; and indicating a usability of the layer stack depending on a signaling based on a processing of the fourth and fifth image acquisitions, respectively.

In a variant, the inspection method comprises the steps of: setting the fourth or fifth image sensor for focusing along its optical axis and/or moving the respective image sensor for focusing along its optical axis during operation. In a variant, the fourth or fifth area for the fourth or fifth image acquisition is illuminated by the respective image sensor by means of a light source assigned to the fourth or fifth image sensor. In a variant, at least one optically active element is assigned to the fourth or fifth image sensor in order to make the corner of the anode or cathode layer located at the top of the layer stack and/or the high edge of the layer stack recognizable in the fourth or fifth image acquisition after the anode or cathode layer has been placed on the layer stack. In a variant, the at least one optically effective element is a lens or lens arrangement, a mirror or a mirror arrangement, a prism or a prism arrangement, a light guide arrangement, an area light, a coaxial ring illumination, a dark-field illumination, a transmitted light illumination, or a combination thereof.

In a variant, the inspection method comprises the following steps: Arranging the transmitted-light illumination on the opposite side of the fourth or fifth image sensor beyond the position of the corner of the anode or cathode layer located at the top of the layer stack and/or the high edge of the layer stack on the stacking table, and for this purpose setting up the transmitted-light illumination to take the corner and/or the high edge of the layer stack into the light beam path. In a variant, processing of the fourth or fifth image acquisition is used to detect at least partial lifting, displacement or twisting of the anode or cathode layer located at the top of the layer stack by causing the uppermost corner and/or the high edge to create an interfering contour.

In a variant, the inspection method comprises the steps of: Arranging the coaxial ring illumination on the side of the fourth or fifth image sensor on this side of the position of the corner of the anode or cathode layer located at the top of the layer stack and/or the high edge of the layer stack on the stacking table, and for this purpose setting up the transmitted light illumination to take the corner and/or the high edge of the layer stack into the light beam path. In a variant, processing of the fourth or fifth image acquisition is used to detect at least partial lifting, displacement or twisting of the anode or cathode layer located at the top of the layer stack by causing the uppermost corner and/or the high edge to create an interfering contour. In a variant, one or more fourth or fifth image sensors are oriented at an angle of approximately ±5° to approximately ±25° to a longitudinal or transverse edge of the anode or cathode layer located at the top of the layer stack, for example ±13°.

In a variant, the inspection method in the manufacture of modules or precursors of modules further comprises the steps of: picking up an anode/cathode layer by means of at least one second pickup of a second layer turner from a second transfer location; delivering the respective individual anode or cathode layer from the respective at least one pickup at a second delivery location onto the stacking table to form the layer stack when the respective second pickup is at the delivery location; directing a fourth image sensor to a fourth region of the layer stack of anode and cathode layers in a planar side view of the layer stack, wherein the fourth region comprises a corner of an anode or cathode layer located on top of the layer stack and/or a high edge of the layer stack; and performing a fourth image acquisition after the anode or cathode layer on the layer stack has been placed on the stacking table; and/or directing a fifth image sensor to a fifth region of the layer stack of anode and cathode layers in a planar side view of the layer stack, the fifth region comprising a corner of an anode or cathode layer located uppermost on the layer stack and/or a high edge (HK) of the layer stack; and executing a fifth image draw after the anode or cathode layer on the layer stack has been placed on the stacking table; and/or wherein the fourth region or wherein the fourth region and the fifth region of the anode or cathode layer in the layer face comprise adjacent or diagonal regions of the layer stack of anode and cathode layers in a respective side view of the layer stack; and indicating a (dis)usability of the layer stack in response to signaling based on processing of the fourth and fifth image acquisitions, respectively.

This further, third inspection can be carried out as an alternative or in addition to the first and/or second inspection.

This procedure allows the exact position of the top layer to be determined in relation to the other layers of the electrode stack. This check becomes increasingly important as the height of the electrode stack increases, as incorrect positioning of the top layer must lead to the electrode stack being rejected without further correction. The inspection becomes increasingly accurate as the height of the electrode stack increases, as the geometric areas to be measured (corner or high edge of the electrode stack) can be recorded and evaluated more easily and precisely.

In a variant of the third inspection, this also allows more precise correction values to be calculated when placing the next layer on the electrode stack. Overall, this procedure with the precise position check allows a considerable reduction in the risk of short circuits, for example in the fuel or battery cells.

This is also made clear by the fact that previous solutions only deposit the layers with an accuracy of around ±0.5 mm, whereas the solution presented here allows an accuracy of ±0.1 mm and more when depositing the anode/cathode layers on the electrode stack in order to reduce waste and improve efficiency.

In a variant of the method, four matrix cameras are used, which (viewed from the side) are directed at all four corners/(high) edges of the electrode stack at the deposit site. In a variant of the method, a backlight or darkfield illumination is achieved by means of respective light sources. This allows the relevant areas of the different anode/cathode layers to be easily recognized. In a variant of the process, mirrors or prisms are used to guide the beam path of the third cameras for adaptation to spatial conditions.

In a variant of the method, a matrix camera is used with a field of view of the electrode stack from the side, which completely captures the electrode stack as a whole in a single image feed, or two matrix cameras, which each capture one of two corners of the electrode stack from the side, up to four matrix cameras, which capture all four corners of the electrode stack from above, and which are directed towards the electrode stack at the deposit site in the side view. Here too, in a variant, the beam path of the cameras is guided by appropriate arrangements of mirrors or prisms etc. for adaptation to spatial conditions. In a variant, coaxial (red) lighting and/or a (white) spotlight are used for the lighting for each of the cameras.

This makes it possible to recognize very precisely that the anode/cathode layers are always placed in the correct position and in the correct orientation on the electrode stack.

In a variant of the method, the movements of the lifting device with the respective workpiece carrier along the vertical axis (z-axis) and their inaccuracies are also taken into account by using the cameras to record the x, y positions of the workpiece carrier at different z heights before the anode/cathode layers are deposited to form the electrode stack. In this way, the cameras can be used to check whether the anode/cathode layers have been stacked at the correct x, y position, which corresponds to the respective z position of the workpiece carrier on the lifting device, while the anode/cathode layers are being deposited. The accuracy in the direction of rotation around the vertical axis (in theta) when picking up the anode/cathode layers with the stacking device can also be corrected in this way for subsequent precise stacking of the anode/cathode layers of the electrode stack.

In a variant of the device, a control unit is intended and set up to determine a position of a stacked anode/cathode layer in relation to the other layers of the electrode stack by checking the position/rotation/offset of the individual anode/cathode layers in relation to one another after the anode/cathode layers have been placed on the electrode stack, and/or wherein the control unit is intended and set up to determine an offset of the individual anode/cathode layers relative to one another with an image acquisition of at least one third camera from at least one (vertical and/or trans-verse) edge of the electrode stack. In a variant of the device, the control unit is intended and set up to check an image indentation obtained by corner/edge search to determine whether one or more of the anode/cathode layers of the electrode stack are above or below the other anode/cathode layers, and/or whether an accuracy has been maintained when stacking the anode/cathode layers.

In a variant of the device, the control unit is intended and set up to determine different dimensions with a (raised) edge stepped in the z-direction in the side view from the image feed in the alternation of stacked anode layers and cathode layers of the electrode stack, and to examine the shape and/or dimensions of the stacked anode layers and cathode layers. In a variant of the device, the control unit is intended and set up to examine the anode layers and cathode layers stacked on top of one another to determine the deviation from the other anode or cathode layers of the electrode stack with which each individual layer is above/below. In a variant of the device, the control unit is intended and set up to examine an image indentation to determine the deviation in the z-direction (vertical axis) with which the various anode/cathode layers form steps in the electrode stack.

In one variant of the device, the control unit is intended and set up to receive image captures from at least two third cameras, which contain image captures from the side onto corners and/or their edges in the vertical axis (z-axis) of the electrode stack at the deposition location, in order to examine, on the anode layers and cathode layers stacked on top of one another, with what deviation in the x or y direction (transverse, longitudinal) relative to the other anode or cathode layers of the electrode stack each individual layer protrudes/protrudes in the longitudinal and/or transverse direction of the layers; and/or to examine with what deviation in the z direction (vertical axis) the various anode or cathode layers of the electrode stack protrude/protrude relative to the other anode or cathode layers of the electrode stack. The electrode stack can be examined to determine the deviation in the x or y direction (transverse, longitudinal) of each individual layer from the other anode or cathode layers of the electrode stack; and/or to examine the deviation in the z direction (vertical axis) with which the various anode/cathode layers form steps in the electrode stack.

In a variant of the device, the at least two cameras are aligned with a (high) edge of the electrode stack and/or (white) spotlights illuminate the desired position on the electrode stack to illuminate the respective edge of the electrode stack.

In a variant of the device, the control unit is intended and set up to receive image acquisitions from at least four cameras, which contain the four corners of the electrode stack at the deposit location as seen from the side, in order to determine a position of the uppermost stacked anode/cathode layer in relation to at least one underlying layer of the electrode stack by checking the position/rotation/offset of the individual anode/cathode layers relative to one another by means of an image feed from each of the four cameras after the anode/cathode layers have been deposited on the electrode stack.

In a variant of the device, the control unit is intended and set up to take into account movements of the lifting device with the respective workpiece carrier along the vertical axis (z-axis) and their inaccuracies by detecting the x-, y-positions of the workpiece carrier at different z-heights with the third cameras by means of image feeds before the start of depositing the anode/cathode layers to form the electrode stack, storing the corresponding data in a data memory for comparison with x-, y-positions of the workpiece carrier at different z-heights during the depositing of the anode/cathode layers in order to check whether the anode/cathode layers have been stacked within the accuracy at the x-, y-position corresponding to the respective z-position of the workpiece carrier on the lifting device, and/or for correcting the orientation in the direction of rotation about the z-axis (vertical axis) (in theta) when picking up and/or depositing the anode/cathode layers.

The procedures and devices described above allow a significant reduction in the risk of short circuits in the module formed in this way, which also leads to an increase in the overall quality and efficiency of the finished fuel or battery cell.

Overall, the device and process described above allows an accuracy of ±0.1 mm or more with a high stack throughput.

Process aspects are shown above in device terms and vice versa. Both the process aspects and the device aspects serve to explain the arrangement and its operation.

### BRIEF DESCRIPTION OF THE DRAWINGS

Further features, properties and advantages of the devices and the methods can be found in the following description in conjunction with the drawing. Possible variations will become clear to a person skilled in the art from the following description, in which reference is made to the accompanying drawings. The Fig. show schematically the devices discussed here and explain their operation. Parts that are identical or analogous in Fig. are not individually marked with reference signs.

FIG. 1 is a schematic front view of a device for manufacturing modules or precursors of modules;

FIG. 2 schematic side view of one of the two layer turners of a device for the production of modules or precursors of modules in a further variant;

FIG. 3 a perspective side view of a layer turner with a stacking table on which a stack of layers is located;

FIGS. 4a and 4b a top view of a stacking table, on which a stack of layers is located, at the first and second depositing locations with a configuration of the image sensors for the second inspection;

FIGS. 5a and 5b a top view of a stacking table, on which a stack of layers is located, at the first and second depositing locations with a configuration of the image sensors for the third inspection;

FIG. 6 a top view of the placement of a stacking table on which a stack of layers is located at the first and second placement locations with a configuration of the image sensors for the second inspection; and

FIG. 7 a top view of a stacking table, on which a stack of layers is located, at the first and second depositing locations with a further configuration of the image sensors for the third inspection.

### DETAILED DESCRIPTION OF THE EMBODIMENTS

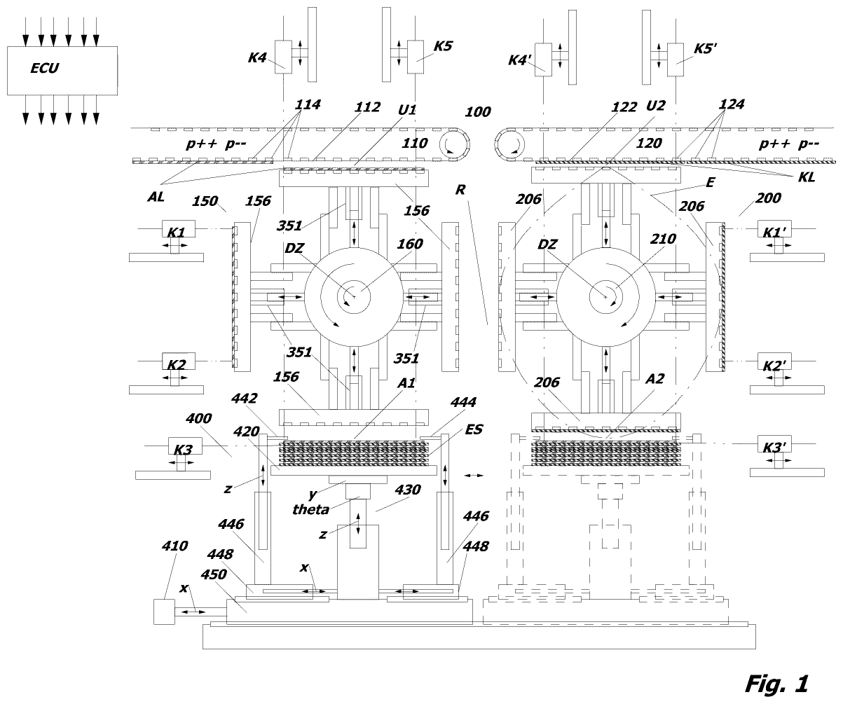

FIG. 1 schematically illustrates a device 100 for manufacturing modules or precursors of modules. Here, the device 100 is explained by way of example using the manufacture of fuel or battery cells containing layer material and/or fluid.

In the device 100, a first conveyor 110 serves to convey individual anode layers AL to a first transfer location U1 for transfer to a first layer turner 150. A second conveyor 120 is used to convey individual cathode layers KL to a second transfer location U2 for transfer to a second layer turner 200.

As illustrated in FIG. 1, the first conveyor 110 and the second conveyor 120 are arranged in the upper region of the device 100 at the same level, adjacent to and at a distance from one another. Here, the first conveyor 110 and the second conveyor 120 are designed as belt conveyors with their respective undersides 112, 122 facing the first and second layer turners 150, 200, respectively. Thus, the first conveyor 110 and the second conveyor 120 can convey the individual anode layers AL or the individual cathode layers KL on their underside 112, 122 to the first or the second transfer location U1, U2. In particular, here the first conveyor 110 and the second conveyor 120 each have a controlled vacuum conveyor belt with suction openings 114, 124 in order to pick up the individual anode layers AL or the individual cathode layers KL by means of pneumatic vacuum p−− supplied in a controlled manner and to hold them during conveying to the first or the second transfer location U1, U2. By means of an optionally controlled pneumatic overpressure p++, the individual anode layers AL or the individual cathode layers KL can be delivered to the first or second layer turners 150, 200, respectively at the first or second transfer location U1, U2 in a controlled and rapid manner. Alternatively, the pneumatic vacuum p−− of the first or second conveyor 110, 120 can be reduced or canceled at the first or second transfer location U1, U2. The first conveyor 110 can take over the individual anode layers AL from a stack or a third conveyor (not shown), in particular a vacuum conveyor belt. The second conveyor 120 can take over the individual cathode layers KL from a stack or a fourth conveyor (not shown), in particular a vacuum conveyor belt.

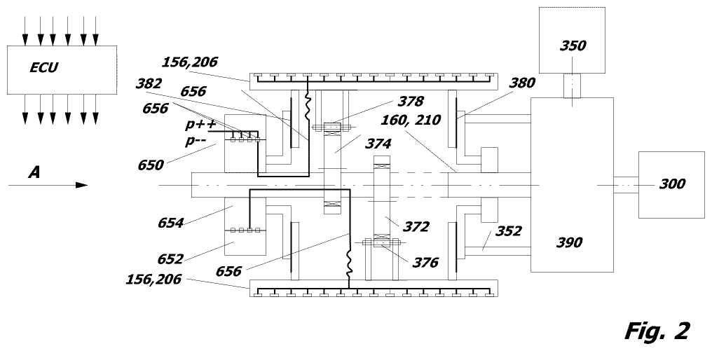

The first and the second layer turners 150, 200 each have four approximately rectangular flat pickups 156, 206 and a first drive 300 (see FIG. 2). The pickups 156, 206 are used to pick up a respective individual anode or cathode layer AL, KL at the respective first or second transfer location U1, U2 of the first or second conveyor 110, 120 in a planar manner. These pickups 156, 206 are indirectly mounted on a rotatably mounted shaft 160, 210 so as to be radially displaceable. This shaft 160, 210 rotates the respective pickups 156, 206 by means of the first drive 300 through a respective angle of rotation RW—here 180°—to a respective first or second delivery location A1, A2. The first drive 300 rotates the layer turners 150, 200 as a whole. Thus, the first and the second layer turners 150, 200 with their respective several pickups are set up to pick up the individual anode or cathode layers AL, KL when the pickups rotate continuously or clocked past the respective transfer location U1, U2 and the respective delivery location A1, A2 one after the other, and pick up or deliver the respective individual anode or cathode layer AL, KL. The first and the second layer turners 150, 200 rotate clockwise or counterclockwise by means of their respective first drive 300 in such a way that the individual anode or cathode layers AL, KL pass from their transfer location U1, U2 to their delivery location A1, A2 avoiding the space R between the first and the second layer turners 150, 200.

It is apparent that the first and second layer turners 150, 200 essentially have a matching structure, matching function and/or matching dimensions.

An endless separator belt, which is not illustrated in detail, is guided from above between the two conveyors 110, 120 into and through the space R and exits at the lower end of the space R from a gap between two rotatably mounted rollers. The separator belt is folded in a Z-shape on the stacking table and the anode and cathode layers are separated from each other by the separator.

The first and the second layer turners 150, 200 have (see FIG. 1) for the pickups 156, 206 as second drive 350 an arrangement of linear drives 351 arranged on slewing rings, of which in each case one linear drive 351 is geared to one of the pickups 156, 206 in order to radially retract and/or extend the pickups of the respective layer turner 150, 200.

In a further variant, the first and the second layer turners 150, 200 each have a second drive 350 (see FIG. 2) for the pickups 156, 206. This second drive 350 serves to retract the respective pickup 156, 206 radially when—after the respective layer has been deposited on the stacking table 400—the pickup of the other layer turner approaches on the way to its pickup location U1, U2 in the space between the two layer turners. The second drive 350 rotates the tube, the turntable connected to it and the pickups 156, 206 around the center of rotation DZ. Due to the coupling to an eccentric described below, the pickups 156, 206 are moved radially. The first drive 300 is a controlled servo motor which rotates the layer turner as a whole in order to turn the pickup about a center of rotation of the layer turner. In the variant illustrated in FIG. 2, the second drive 350 is a servo motor which is to be controlled independently of the first rotary drive 300 and which is geared to the inner shaft 160, 210 designed as an eccentric shaft. This eccentric shaft is provided with eccentrics 372, 374 for each of the pickups in order to radially retract and extend the pickups 156, 206 of the respective layer turner 150, 200. For this purpose, each eccentric 372, 374 is surrounded by a needle bearing, which carries a ring 376, 378 on the outside, which is articulated to the respective pickup 156, 206. When the shaft 160, 210 is rotated, the respective eccentric 372, 374 causes the respective transducers 156, 206, which are guided in radially oriented linear guides 380, 382, to move outwards or inwards. In particular, a radial retraction of the pickups of the first and/or the second layer turner takes place when the pickup approaches a pickup of the other layer turner on the way from its delivery location to its transfer location or from its transfer location to its delivery location.

The second drive 350 rotates the respective inner shaft 160, 210 and causes the transducers to extend and retract radially. In particular, the second drive 350 also serves to cause the first and second layer turners to radially extend the respective pickups when the pickups approach the respective first and second transfer locations U1, U2 and the first and second delivery locations A1, A2. Overall, in this variant, the pickups of the two layer turners each move approximately on an approximate, stationary ellipse, the main axes of which extend from the center of the respective transfer location to the center of the respective delivery location and the secondary axes of which do not touch each other. In FIG. 1, this ellipse E is illustrated with a dotted line on the second layer turner 200. It can be seen that this movement does not have to be symmetrical, as the pickup located away from space R is extended radially further than the pickup located in space R.

The first drive 300 and the second drive 350 are brought together via a combined angular and axial gear 390 and independently of one another set the inner shaft 160, 210 or all the pickups of a layer turner as a whole in rotation via a connecting element, for example a tube 352. As illustrated in FIG. 2, the tube 352 and the shaft coupled to the first drive 300 have collinear axes of rotation.

A stacking table 400 for receiving the individual anode or cathode layers AL, KL at the respective first or second delivery location A1, A2 is provided with a drive 410. This drive 410 moves the stacking table 400 back and forth along the x-axis between the first and the second delivery location A1, A2 in a controlled manner, so that the stacking table 400 is precisely aligned with the position of the individual anode or cathode layer AL, KL to be deposited on it. In FIG. 1, the stacking table is shown in its left aligned position under the layer turner 150 in solid lines, and in its right aligned position under the layer turner 200 in short dashed lines.

The first and second layer turners 150, 200 each deliver a single anode or cathode layer AL, KL from their pickup 156, 206—in the 6 o'clock position in FIG. 1—to the stacking table 400 at the first and second delivery locations A1, A2, respectively, when the pickup 156, 206 is located at the first and second delivery locations A1, A2, respectively.

For this purpose, in the variant of the device 100 illustrated here, the first and second transfer locations U1, U2 each have a first center (approximately above the center of the pickup located in the 12 o'clock position between the pickup and the conveyor), and the first and second delivery locations A1, A2 each have a second center (approximately below the center of the pickup located in the 6 o'clock position between the pickup and the stacking table). These respective first and second centers lie on an imaginary straight line that intersects a respective center of rotation DZ of the first layer turner 150 and the second layer turner 200, respectively. The first and second layer turners each turn only individual anode layers AL and only individual cathode layers KL towards the first and second delivery locations A1, A2 respectively.

In the arrangement with the eccentric drive, the first drive of a layer turner and the second drive of the same layer turner can rotate continuously in the same direction or even temporarily in opposite directions. This allows the rotary movement of the layer turner as a whole to be superimposed on the radial inward/outward movement of its pickups in such a way that a particularly small distance between the two layer turners, and thus a particularly short distance between the two delivery locations, is possible. In addition, the two layer turners (in both variants of FIGS. 1 and 2) can be rotated by their respective first drives in such a way that the pickup(s) of one layer turner rotate in exactly the opposite phase to the pickup(s) of the other layer turner. This means that in the case of one pickup per layer turner, one pickup of one layer turner is located near the transfer location, while one pickup of the other layer turner is located near the delivery location. In the case of four pickups per layer turner, one pickup of one layer turner precedes a pickup of the other layer turner by approximately 45°.

The stacking table 400 has a tray 420 for the individual anode and cathode layers AL, KL and a positioning device 430 with a corresponding rotary drive about the z-axis, which moves the tray 420 along the axes and about the z-axis. In this way, the stacking table 400 and its tray 420, or more precisely its center, can be precisely aligned with the first and second delivery locations A1, A2 and the pickup in the 6 o'clock position.

The stacking table 400 has a first and a second clamping finger 442, 444. In a variant, two clamping fingers are provided on each of two opposite sides. The clamping fingers move in the y-direction perpendicular to the plane of rotation of the pickups. These two clamping fingers 442, 444 grip from both (transverse or longitudinal) sides along the x- or y-direction laterally over the electrode stack formed from the anode and cathode layers AL, KL and come into or out of engagement with the uppermost of the anode and cathode layers AL, KL in a controlled manner in order to press the uppermost of the anode and cathode layers AL, KL against the electrode stack ES on the support 420. For this purpose, corresponding linear drives 446, 448 are provided in the z-direction and in the x-direction or y-direction, depending on the arrangement of the clamping fingers 442, 444, which move the first and second clamping fingers 442, 444 in a controlled manner relative to the base plate 450 of the stacking table 400 and to its support 420. In a variant, the stacking table 400 is supported on a rigid plate which has a recess. The base plate 450 can only be moved in the x-direction along two linear guides relative to the rigid plate. A Y-plate is located on the base plate 450, which can be moved in the y-direction relative to the base plate 450. The Y-plate carries an actuator plate. The actuator plate carries the tray 420. The actuator plate can be rotated around the z-axis together with the tray 420 and thus also the clamping fingers and their actuators.

There is an x- or y-actuator for each clamping finger on the actuator plate, depending on the direction of movement and arrangement of the clamping fingers, in order to be able to position a single clamping finger in the y-direction. The z-actuator of each clamping finger is arranged on a separate plate, which is arranged on the Y-plate and next to the tray 420. The y-actuator thus displaces the separate plate and thus the respective clamping finger 442, 444 together with its z-actuator.

The clamping fingers 442, 444 also serve to clamp the endless separator belt against the tray 420 or the previously formed stack during the movement of the stacking table between the delivery locations A1, A2, so that anode and cathode layers Al, KL deposited on the tray 420 are always separated by the electrically insulating separator.

When the Y-plate is displaced in the y-direction, the actuator plate is also displaced in the y-direction together with the clamping fingers. The shelf 420 can be positioned in the z-direction by a z-drive, which can be arranged exactly below the shelf and has room for movement in the x-direction in the central recess of the rigid plate.

The first and the second layer turners 150, 200 are arranged to pick up the individual anode layers AL and the individual cathode layers KL by means of controlled pneumatic negative pressure p−− and to hold them during turning to the first and the second delivery location A1, A2, respectively. Furthermore, in the variant of the device 100 shown here, the first and the second layer turners 150, 200 are set up to release the individual anode layers AL and the individual cathode layers KL in the first and the second delivery location by means of a short blowing burst by means of controlled pneumatic overpressure p++, in order to stack the layers AL, KL on the deposit 420 to form the electrode stack ES.

For this purpose, it is illustrated in FIG. 2 that the first and the second layer turners 150, 200 each have a rotatable positive/negative pressure distribution 650, which is arranged around the inner shaft 160, 210 in order to feed the transducers with the controlled pneumatic negative pressure p−− and/or positive pressure p++. Two concentric rings 652, 654 are rotatably provided, surrounding each other in a fluid-tight manner, in which an over/under pressure transfer 656 is realized for each of the transducers. A fluid line extends from the over/under pressure transfer 656 for each transducer 156, 206 into the inner shaft 160, 210 and from there to a connection for a radially flexible line 656 to the respective transducer 156, 206. The flexible line 656 is connected to a plurality of openings in the surface of the transducers facing away from the center of rotation.

Alternatively, each of these openings is associated with an elastic nozzle, which protrudes slightly (for example less than 3 mm) above the surface of the pickup and is connected to the flexible line 656. This allows the anode layers AL and cathode layers KL to be picked up safely and gently and released with high precision in their alignment on the deposit 420. The positioning device 430 lowers the tray 420 in a controlled manner during stacking after each depositing of the individual anode layers AL and the individual cathode layers KL by a distance corresponding to the thickness of an individual anode layer AL or an individual cathode layer KL. This ensures a very short, defined free path between the release from the pickup 156, 206 and the impact on the electrode stack ES.

The first to third inspection of the layer material integrated in the above variants, for example in the manufacture of fuel or battery cells, is illustrated below.

The first inspection device has a first layer conveyor 150 (on the left in FIG. 1) with four pickups 156 and a first drive 300 in order to pick up a respective individual anode or cathode layer AL, KL by means of the at least one pickup 156 from a first transfer location U1 and to bring it to a first delivery location A1. The first layer turner 150 delivers a respective individual anode or cathode layer AL, KL from its pickup 156 to the stacking table 400, or more precisely onto the stacking table 420, at the first delivery location A1 when the respective at least one pickup 156 is located at the first delivery location A1. The drive 410 aligns the pickup 156 and the stacking table 400 relative to each other depending on a signaling based on a processing of the first and/or second image feed. A first image sensor K1 is aligned with a first area E1 of the first layer turner 150 between the first transfer location U1 and the first delivery location A1 and performs a first image acquisition when the pickup 156 of the first layer turner 150 with the individual anode or cathode layer AL, KL passes the first image sensor K1. A second image sensor K2 is aligned between the first transfer location U2 and the first delivery location A2 to a second area E2 of the first layer turner 150 and performs a second image acquisition when the pickup 156 of the first layer turner 150 passes the image sensor K2 with the single anode or cathode layer AL, KL. The second area E2 may be different from the first area E1. The stacking table 400 picks up the respective individual anode layer AL at the first delivery location A1 and the respective individual cathode layer KL at the second delivery location A2 to form a layer stack.

In the variant shown, the first layer conveyor 150 has a layer turner 156 to pick up a respective individual anode or cathode layer by means of the at least one pickup 156 from the first transfer location U1 and to rotate it through a respective rotation angle—here about 180°—to the first delivery location A1.

In a variant not shown further here, the first layer conveyor 150 has a layer gripper which picks up a respective individual anode or cathode layer from the first transfer location U1 by means of a pickup, for example in the form of a suction or gripping tool, and brings it to the first delivery location A1.

Analogous to the first layer conveyor 150, a second layer conveyor 200 (on the right in FIG. 1) is provided and set up to pick up a single cathode or anode layer KL, AL and bring it to a second delivery location A2. A first image sensor K1′ between the second transfer location U2 and the second delivery location A2 is aligned with a first region E1′ of the second layer conveyor 200 and performs a first image acquisition when the second layer conveyor 200 passes the first image sensor K1′. A second image sensor K2′ is aligned between the second transfer location U2 and the second delivery location A2 to a second area E2′ of the second layer conveyor and performs a second image acquisition when the second layer conveyor passes the second image sensor K2′.

In the variant shown, the second layer conveyor 200 has a layer turner 206, which picks up a respective individual anode or cathode layer by means of the at least one pickup 206 from the second transfer location U2, and rotates it through a respective angle of rotation—here 180°—to a second delivery location A2.

In a variant not shown further here, the second layer conveyor 200 has a layer gripper which is provided and set up to pick up a respective individual anode or cathode layer from the second transfer location U2 by means of a pickup, for example in the form of a suction or gripping tool, and to bring it to the second delivery location A2.

A drive 410 is associated with the stacking table 400, which moves the stacking table 400 back and forth between the first and second delivery locations A1, A2. The first and second layer conveyors each deliver a single anode or cathode layer AL, KL to the stacking table 400 at the first and second delivery locations A1, A2, respectively, when the stacking table 400 is located at the first and second delivery locations A1, A2, respectively. A drive aligns the respective layer conveyor and/or the respective at least one layer turner 156, 206 to the stacking table 400 depending on a signaling based on a processing of the first and the second image feed.

The first region E1 and the second region E2 of the transducers of the two layer turners 150, 200 are here corner regions of the transducer of the layer turners 150, 200 which are located diagonally to one another. The first region E1 and the second region E2 of the transducers of the two layer turners 150, 200 are provided and set up for receiving a first corner or second corner of the individual anode or cathode layer AL, KL. Consequently, the first and second image sensors K1, K2, K1′, K2′ are arranged diagonally to each other and aligned with the first area E1 and the second area E2 of the pickups of the two layer turners 150, 200 when these pass the first and second image sensors K1, K2, K1′, K2′. The first and second image sensors K1, K2, K1′, K2′ are arranged here between the two transfer locations U1, U2 and the two delivery locations A1, A2 in such a way that they are aligned with the first and second areas E1, E2 of the respective pickups 156, 206 at the time of the first and/or second image acquisition at an angle of approximately 90° between the camera axis and the anode or cathode in the inspection position for the first and second image sensors K1, K2, K1′, K2′.

The first and/or the second image sensor K1, K2, K1′, K2′ can be adjusted along their optical axes for focusing. In other variants, they are instead or additionally movable during operation. White light sources assigned to the first and second image sensors K1, K2, K1′, K2′ illuminate the anode/cathode position for image acquisition. In further variants, one or more optically effective elements are assigned to the first or the second image sensor K1, K2, K1′, K2′ in order to detect the position and/or orientation of the anode/cathode layer at one or more locations or areas before or on its arrival at the delivery location or on the way to the delivery location. Optically effective elements can be a lens or lens arrangement, a mirror or a mirror arrangement, a prism or a prism arrangement, an optical fiber arrangement, an area light, a coaxial ring light, a dark-field light, etc., or combinations thereof.

The control unit ECU determines correction values from the image indent(s) from the position and/or orientation of the anode/cathode layer AL, KL before it is picked up by the stacking table 400, the position and/or orientation of the stacking table 400, and/or the position and/or orientation of the picked up individual anode/cathode layer AL, KL relative to the stacking table 400 during a turning of the anode/cathode layer AL, KL to the stacking table 400. The control unit ECU takes these correction values into account when aligning the stacking table 400 with the transported anode/cathode layer relative to the deposit location A1, A2 in positioning commands to the layer turner, the pickup and/or the stacking table. The control unit 400 takes into account these correction values, in particular for the alignment and the location of the stacking table when picking up the anode/cathode layer, in positioning commands to the layer turner, the pickup and/or the stacking table in such a way that the stacking table picks up the respective anode/cathode layer in a central zero position and/or aligned with the electrode stack located at the delivery location.

The control unit determines the orientation and location of the stacking table 400 during or before picking up the anode/cathode layer AL, KL by checking the position of the incoming anode/cathode layer AL, KL in the image inserts immediately before the respective delivery location A1, A2.

An inspection method with the following steps is also used for inspection: Picking up an anode/cathode layer AL, KL by means of a pickup 156 of a layer turner 150, 200 from a transfer location U1, U2; conveying the pickup 156 of the layer turner 150, 200 from the transfer location to a delivery location A1, A2; detecting the position and/or orientation in x, y, z, and/or theta of the anode/cathode layer AL, KL at the pickup 156 of the layer turner 150, 200 by means of a first image sensor K1 between the transfer location U1 and the delivery location A1, the first image sensor K1 being aligned with a first region E1 of the layer turner 150 and being provided and set up for a first image acquisition when the pickup of the layer turner passes the first image sensor K1; detecting the position and/or orientation in x, y, z, and/or theta of the anode/cathode layer AL, KL at the at least one pickup 156 of the layer turner 150, 200 by means of a second image sensor K2 between the transfer location U1, U2 and the delivery location A1, the second image sensor K2 being aligned with a second region E2 of the layer turner 150 and being provided and set up for a second image acquisition when the pickup of the layer turner passes the second image sensor K2; aligning the pickup 156 and the stacking table 400, more specifically the stacking table 420, relative to each other in dependence on a signaling based on a processing of the first and/or second image acquisition; and delivering the anode or cathode layer AL, KL from the pickup 156 at the delivery location A1, A2 to the stacking table 400 to form a layer stack when the respective pickup 156 is at the delivery location A1, A2.

The first and second image sensors K1, K2 detect the position and/or orientation of the anode/cathode layer AL, KL in x, y, z, and/or theta in a vertical top view of the anode/cathode layer when the sensor of the layer turner passes the respective image sensor K1, K2. A light source L1, L2 assigned to the first and/or the second image sensor K1, K2 illuminates the anode/cathode position AL, KL for an image acquisition by the first and the second image sensor K1, K2. In a variant not illustrated, the first and second image sensors K1, K2 detect the anode/cathode position AL, KL completely with an image acquisition in order to detect its position and/or orientation in x, y, z, and/or theta. In a further variant, the first and/or the second image sensor K1, K2 detect a region, at least one corner region, two diagonal corner regions, or at least one corner region and at least a section of an edge of the anode/cathode layer AL, KL relative to a respective defined image sensor zero location with a single image acquisition in order to detect the position and/or orientation in x, y, z, and/or theta of the anode/cathode layer AL, KL. The first or the second image sensor K1, K2 can be designed as matrix cameras or as line scan cameras, which detect the position and/or orientation in x, y, z, and/or theta of the anode/cathode layer AL, KL before or when it arrives at the delivery location A1 or on the way to the delivery location A1.

The correction values are determined from the position and/or orientation in x, y, z, and/or theta of the anode/cathode layer AL, KL after it has been picked up by the at least one pickup of the layer turner, the position and/or orientation in x, y, z, and/or theta of the stacking table 400, and/or the position and/or orientation in x, y, z, and/or theta of the picked up individual anode/cathode layer AL, KL during a turning of the anode/cathode layer AL, KL to the stacking table 400. These correction values are taken into account when aligning in x, y, z, and/or theta the stacking table 400 at the delivery location A1, A2 relative to the pickup of the layer turner with the transported anode/cathode layer AL, KL at the delivery location A1, A2. These correction values are taken into account in x, y, z, and/or theta when aligning the stacking table 400 or the pickup of the layer turner in such a way that the anode/cathode layer AL, KL is picked up by the stacking table 400 in a centered zero position and/or aligned.

In the second inspection device 100, the first layer conveyor 150 picks up a single anode or cathode layer AL, KL from a first transfer location U1 and brings it to a first delivery location A1. A stacking table 400, or more precisely its tray 420, picks up the single anode or cathode layer AL, KL at the first delivery location A1 to form a layer stack. The first layer conveyor 150 delivers a single anode or cathode layer AL, KL to the stacking table 400 at the first delivery location A1 when the stacking table 400 is located at the first delivery location A1. A third image sensor K3, K3′ is directed towards at least one region E3, E3′ comprising an upper edge OK of a stack of layers located on the stacking table 400 in a side view. This region E3, E3′ comprises a connection tab T of an anode or cathode layer AL, KL located at the top of the layer stack. The third image sensor K3, K3′ performs a third image acquisition after the anode or cathode layer AL, KL is deposited on the layer stack on the stacking table 400. A control unit ECU indicates the (un)usability of the layer stack depending on a signaling based on the processing of the third image acquisition.

The layer conveyor here has a layer turner, which picks up individual anode or cathode layers from the first transfer location U1 by means of one of four pickups 156 and rotates them through a respective angle of rotation—here 180°—to the first delivery location A1.

In a variant not illustrated further, the layer conveyor has a layer gripper which picks up a respective individual anode or cathode layer from the first transfer location U1 by means of a pickup, for example in the form of a suction or gripper tool, and brings it to the first delivery location A1.

A second layer conveyor, analogous to the first layer conveyor, picks up a single cathode or anode layer KL, AL and brings it to a second delivery location A2. A drive 410 is associated with the stacking table 400, which moves the stacking table 400 back and forth between the first and second delivery locations A1, A2. The first and second layer conveyors each deliver a single anode or cathode layer AL, KL to the stacking table 400 at the first and second delivery locations A1, A2, respectively, when the stacking table 400 is located at the first and second delivery locations A1, A2, respectively. At least one drive is used to align the respective layer conveyor and/or the respective at least one layer turner 156, 206 or layer gripper relative to the stacking table 400 as a function of a signaling based on processing of the first and/or second image feed in a control ECU.

The second layer conveyor also has a layer turner and also picks up a single anode or cathode layer by means of the pickup 206 from the second transfer location U2 and rotates it through an angle of rotation—here 180°—to a second delivery location A2.

In a variant not shown, the second layer conveyor has a layer gripper which picks up a respective individual anode or cathode layer from the second transfer location U2 by means of a pickup, for example in the form of a suction or gripper tool, and brings it to the second delivery location A2.

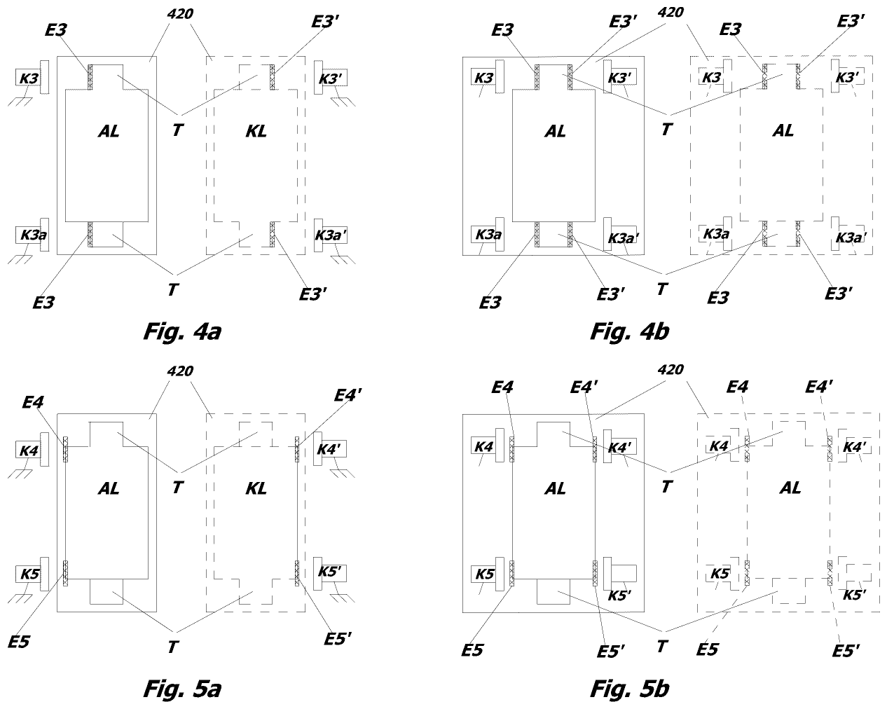

A first third area E3 and a second third area E3′—see FIG. 4a—of the layer stack each comprise—in the side view—a connection tab of the respective uppermost anode or cathode layer AL, KL on the stacking table 400 at the first or the second delivery location A1, A2. One or two third image sensors K3, K3a, K3′, K3a′ are arranged on a first side, for example the left side in FIG. 1, of the inspection device 100 or the stacking table 420, and one or two third image sensors K3, K3a, K3′, K3a′ are arranged on a second side, for example the right side in FIG. 1, of the inspection device 100, which is opposite the first side. Two third image sensors K3, K3a, K3′, K3a′ on one side of the inspection device 100 or the tray 420 are spaced apart from each other with respect to a Y-direction. In a variant, one or more third image sensors K3, K3a, K3′, K3a′ are arranged in a fixed position relative to the stacking table 400 moving back and forth between the two delivery locations A1, A2. This is illustrated in FIG. 4a. In variants not shown in detail, only two of the four stationary third image sensors K3, K3a′ K3a, K3′ are provided, i.e. in FIG. 4a the third image sensors K3, K3a′ or the third image sensors K3a, K3′ are arranged diagonally. Alternatively, in variants not shown in detail, only two of the four stationary third image sensors K3, K3a′ K3a, K3′ are provided, i.e. in FIG. 4a the third image sensors K3, K3a or the third image sensors K3a', K3′, arranged on one side of the stacking table 400. In a variant, an optical axis of the one third image sensor or of each of the several image sensors is oriented horizontally or has a maximum deviation of +/−10° from a horizontal.

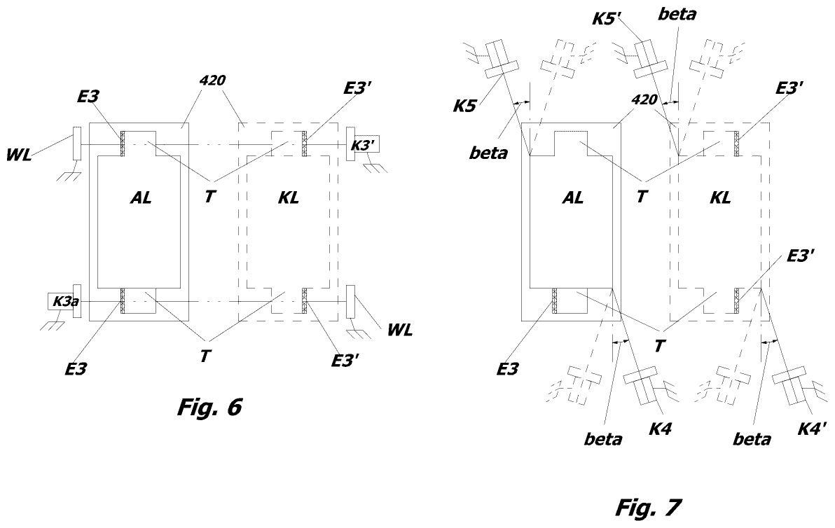

As a further variant of this, FIG. 6 shows a top view of the delivery 420 of a stacking table, on which a stack of layers is located, at the first and second delivery locations with a configuration of the image sensors for the second inspection. The third image sensors K3a, K3′ are illustrated as examples, which capture the first and second third areas E3, E3′ with backlight or transmitted light from light sources WL in each case—in the side view from the outside. In this way, a connection tab of the respective uppermost anode or cathode layer AL, KL on the stacking table 400 is inspected at the first or second delivery location A1, A2.

If space permits, in other variants one or more third image sensors K3, K3a, K3′, K3a′ are firmly connected to the stacking table 400—see FIG. 4b—and can be moved with it between the two delivery locations A1, A2. In variants not shown in detail, only two of the four third image sensors K3, K3a′ K3a, K3′ that can be moved with the stacking table are provided, i.e. in FIG. 4b the third image sensors K3, K3a′ or the third image sensors K3a, K3′. Alternatively, in variants not shown in detail, of the four third image sensors K3, K3a′ K3a, K3′ that can be moved with the stacking table, only two third image sensors arranged on one side of the stacking table 400 are provided, i.e. in FIG. 4b the third image sensors K3, K3a that can be moved with the stacking table or the third image sensors K3a′, K3′ that can be moved with the stacking table.

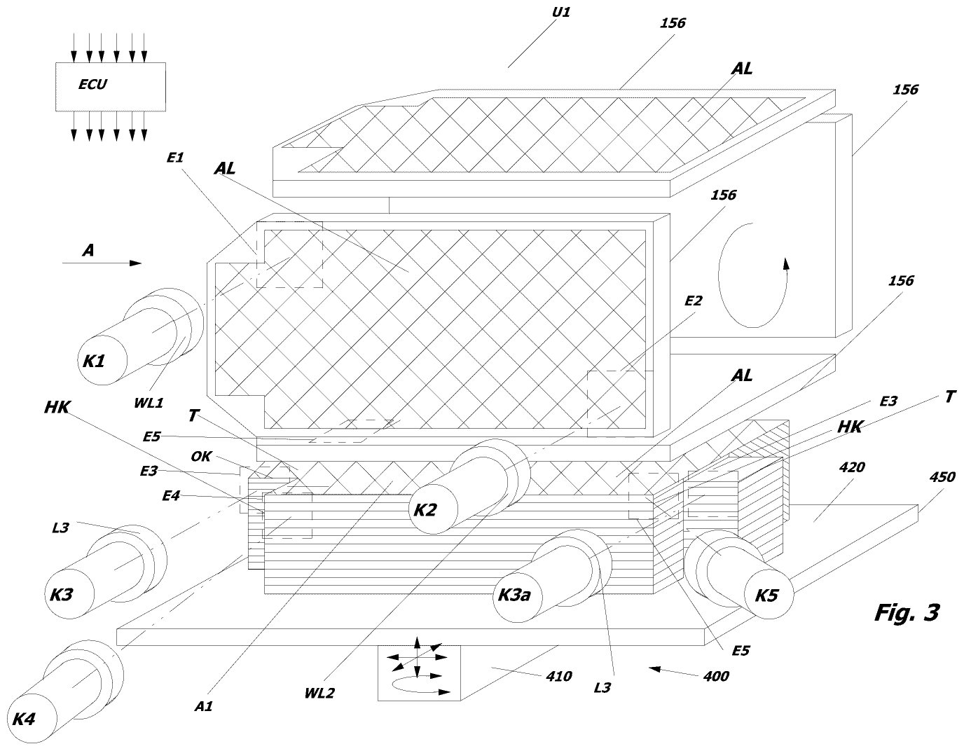

The third image sensor(s) K3, K3a, K3′, K3a′ are adjustable along their optical axis for focusing on the areas E3, E3′. A light source L3 assigned to the third image sensor(s) K3, K3a, K3′, K3a′—see FIG. 3—illuminates the anode/cathode layer on the layer stack for an image acquisition by the third image sensor(s). Here the light source L3 is a coaxial ring illumination. The coaxial ring illumination is arranged on the side of the third image sensor K3, directly at the respective third image sensor K3, K3a, K3′, K3a′ on this side of the position of the connection tab T on the stacking table 400, and is set up to take the connection tab T into the light beam path. Thus, by processing the third image acquisition, a vertical lift-off of the connection tab T can be detected, in that the uppermost edge of the connection tab T is not oriented horizontally in the image acquisition and/or causes an interfering contour.

A second inspection method in the manufacture of modules or precursors of modules comprises the steps of: picking up an anode/cathode layer AL, KL at the first transfer location U1 and bringing the anode or cathode layer AL, KL from the first transfer location U1 to a first delivery location A1; delivering the respective individual anode or cathode layer AL, KL at the delivery location A1, A2 onto a stacking table 400 to form a layer stack; directing a third image sensor K3, K3′ onto a region E3 comprising an upper edge OK of a layer stack located on the stacking table 400 in a side view, wherein the region comprises a connection tab T of an anode or cathode layer AL, KL located uppermost on the layer stack; and wherein a third image acquisition is carried out by means of the third image sensor K3, K3′ after the anode or cathode layer AL, KL on the layer stack has been removed. cathode layer AL, KL is deposited on the stacking table 400; and indicating an unusability of the layer stack depending on a signaling based on a processing of the third image acquisition.

In the variant shown, the coaxial ring illumination is arranged on the side of the third image sensor, on this side of the position of the terminal tab T on the stacking table 400, and the third image sensor K3 is set up so that the terminal tab T is taken into the light beam path. Finally, the third image acquisition takes place, which is processed in the ECU in order to detect a lift-off of the connection tab T by means of processing of the third image acquisition, in that the uppermost edge of the connection tab T is not oriented horizontally and/or causes an interfering contour in the third image acquisition.

In a third inspection device 100 for layer material, in particular for the production of fuel or battery cells, a first layer conveyor 150 picks up a single anode or cathode layer AL, KL and brings it to a first delivery location A1. A stacking table 400 picks up the anode or cathode layer AL, KL at the first delivery location A1 to form a layer stack. The first layer conveyor 150 delivers the anode or cathode layer AL, KL to the stacking table 400 at the first delivery location A1. A fourth image sensor K4 is aligned with a fourth area E4 of the layer stack of anode and cathode layers AL, KL in a planar side view of the layer stack and performs a fourth image acquisition after the anode or cathode layer AL, KL is deposited on the layer stack on the stacking table 400, wherein the fourth region E4 comprises a corner of an anode or cathode layer AL, KL located uppermost on the layer stack and/or a high edge HK of the layer stack. Not only the topmost stacked layer, but also one or more incorrectly positioned layers further down in the overall stack can be detected in this way. In this way, outliers that have shifted due to changes in the processes can be found. In the variant shown, a fifth image sensor K5 is aligned with a fifth area E5 of the layer stack consisting of anode and cathode layers AL, KL in a planar side view of the layer stack and performs a fifth image acquisition after the anode or cathode layer AL, KL is deposited on the layer stack on the stacking table 400, wherein the fifth region E5 comprises a corner of an anode or cathode layer AL, KL located at the top of the layer stack (or below, see above) and/or a high edge HK of the layer stack. The areas E4 and E5 are disjoint here. In particular, the fourth region E4 or the fifth region E5 of the anode or cathode layer AL, KL comprise regions of the layer stack of anode and cathode layers AL, KL that are adjacent or diagonal to one another in the layer surface in a respective side view of the layer stack.

The layer conveyor comprises a layer turner 156 for picking up a single anode or cathode layer by means of at least one pickup 156 from the first transfer location U1 and rotating it through a respective rotation angle—here 180°—to the first delivery location A1.

The fourth image sensor K4 and the fifth image sensor K5 are adjustable along their optical axis for focusing. A light source assigned to the fourth image sensor K4 and the fifth image sensor K5 illuminates the anode/cathode position for a fourth image acquisition or a fifth image acquisition by the fourth image sensor K4 or the fifth image sensor K5. At least one optically effective element is assigned to the fourth image sensor K4 or fifth image sensor K5, respectively, to make the corner E4 or E5 of the anode or cathode layer AL, KL located at the top of the layer stack and the respective high edge HK of the layer stack recognizable in the fourth image sensor or the fifth image sensor after the anode or cathode layer AL, KL is deposited on the layer stack. The at least one optically effective element here is a coaxial ring illumination. The coaxial ring illumination is located on the side of the fourth image sensor K4 or the fifth image sensor K5, on this side of the position of the corner of the anode or cathode layer AL, KL located at the top (or further down, see above) on the layer stack and the respective high edge HK of the layer stack. Together with the respective image sensor, it takes the corner and/or the high edge HK into the light beam path. Thus, by processing the fourth image acquisition or the fifth image acquisition, a lift-off, displacement or rotation about the vertical axis of the anode or cathode layer AL, KL can be detected by the corner and/or the high edge HK causing an interfering contour in the image acquisition.

A first fourth region E4 and a second fourth region E4′ of the layer stack each comprise a corner of the anode or cathode layer AL, KL located at the top of the layer stack and a high edge HK of the layer stack on the stacking table 400 when the stack is located at the first and second delivery locations A1, A2, respectively.

In a variant, a first fourth image sensor K4 and a first fifth image sensor K5 are arranged on a first side of the inspection device 100 (on the left in FIG. 5a), and a second fourth image sensor K4′ and a second fifth image sensor K5′ are arranged on a second side of the inspection device 100 opposite the first side (on the right in FIG. 5a). In FIG. 5a, these several fourth and fifth image sensors are arranged in a fixed position relative to the movable stacking table 400, or more precisely its support 420. In FIG. 5b, these several fourth or fifth image sensors are connected to the stacking table 400 in order to be movable therewith.

In order to realize a compact and low-vibration overall arrangement of the inspection device for the inspection, in a variant the first and/or the second image sensor K1, K2, optionally also the first fourth image sensor K4 and/or the first fifth image sensor K5, are arranged on a support frame which extends parallel to the pickup 156 when the pickup 156 passes the first and/or second image sensor K1, K2. In a further embodiment, the support frame can be L-shaped (horizontal L) and surround the layer turner 150 in an L-shape, so that a side of the layer turner 150 facing away from the first drive 300 (see FIG. 2) is accommodated on the support frame so that it can rotate. Such a support frame can also be assigned to the second layer turner 200 for the same purpose, in order to accommodate the image sensors assigned to the second layer turner 200.

In variants not shown in detail, of the four fourth and fifth image sensors K4, K4′ K5, K5′, only two diagonally arranged image sensors are provided, i.e. in FIG. 5a or FIG. 5b the image sensors K4, K5′ or the image sensors K4′, K5. Alternatively, in variants not shown in detail, only two of the four fourth and fifth image sensors K4, K4′ K5, K5′ movable with the stacking table are provided on one side of the stacking table 400, i.e. in FIG. 5b the image sensors K4, K5 movable with the stacking table 400 or the image sensors K4′, K5′ movable with the stacking table.

As a further variant of this, FIG. 7 shows a top view of the delivery of a stacking table, on which a stack of layers is located, at the first and second delivery locations with a configuration of the image sensors for the third inspection. As an example, the fourth or fifth image sensor K4, K5, K4′, K5′ are oriented at an angle beta of about ±5° to about ±25° to a longitudinal or transverse edge of the anode or cathode layer AL, KL, for example about ±13°, located at the top of the layer stack. This avoids a disturbing influence of the (not illustrated) loop-shaped or S-shaped endless separator. The optical axis of the fourth or fifth image sensors K4, K5, K4′, K5′ at the first or second delivery location A1, A2, as viewed from above, can be inclined either to the left or right of the (imaginary) extended transverse or longitudinal edge of the anode or cathode layer AL, KL located at the top of the layer stack by the angle beta. This is illustrated by the dashed image sensors in FIG. 7. Thus, a corner region of the respective uppermost anode or cathode layer AL, KL on the stacking table 400 is inspected at the first or second delivery location A1, A2. A third inspection method comprises the steps of: picking up an anode/cathode layer AL, KL by means of at least one pickup 156, 206 of a layer turner 150, 200 from a transfer location U1, U2; delivering the respective individual anode or cathode layer AL, KL from the respective at least one pickup 156 at a delivery location A1, A2 onto a stacking table 400 to form a layer stack when the respective at least one pickup 156, 206 is located at the delivery location A1, A2; directing a fourth image sensor K4 to a fourth region E4 of the layer stack of anode and cathode layers AL, KL in a planar side view of the layer stack, wherein the fourth region E4 comprises a corner of an anode or cathode layer AL, KL located at the top of the layer stack and/or a high edge HK of the layer stack; and executing a fourth image feed after the anode or cathode layer AL, KL has been placed on the layer stack on the stacking table 400; and/or directing a fifth image sensor K5 to a fifth region E5 of the layer stack of anode and cathode layers AL, KL in a planar side view of the layer stack, wherein the fifth region E5 comprises a corner of an anode or cathode layer AL, KL located uppermost on the layer stack and/or a high edge HK of the layer stack; and executing a fifth image acquisition after the anode or cathode layer AL, KL on the layer stack has been deposited on the stacking table 400. Here, the fourth region E4 or the fifth region E5 of the anode or cathode layer AL, KL comprise regions of the layer stack of anode and cathode layers AL, KL adjacent to each other (for example lying on the same edge of the layer) or diagonal to each other in a respective side view of the layer stack; and indicating a (dis)usability of the layer stack depending on a signaling based on a processing of the fourth or the fifth image acquisition.

The fourth or fifth image sensor K4, K5 is adjustable along its optical axis for focusing. The fourth or fifth area E4, E5 for the fourth or fifth image acquisition is illuminated by the respective image sensor K4, K5 K4′, K5′ by means of a light source assigned to the fourth or fifth image sensor. An optically effective element is assigned to each of the fourth and fifth image sensors, here in the form of a coaxial ring illumination to make the corner of the anode or cathode layer AL, KL located at the top of the layer stack and/or the high edge HK of the layer stack in the fourth and fifth image sensors recognizable after the anode or cathode layer AL, KL has been placed on the layer stack. The coaxial ring illumination is arranged as incident light on the side of the fourth or fifth image sensor, on this side of the position of the corner of the anode or cathode layer located at the top of the layer stack or the high edge of the layer stack on the stacking table. For this purpose, the incident light illumination is set up to take the corner and the high edge HK of the layer stack into the light beam path. By processing the fourth or fifth image acquisition, this allows at least partial lifting, displacement or twisting of the anode or cathode layer AL, KL located at the top of the layer stack to be detected, in which the uppermost corner and/or the high edge HK causes an interfering contour.

The variants of handling and inspection described above, their structural and operational aspects, as well as the variants of the method are only intended to provide a better understanding of the structure, the mode of operation and the properties; they do not limit the disclosure to the embodiments. The figures are partly schematic. Essential properties and effects are shown, in some cases clearly enlarged, in order to clarify the functions, operating principles, technical embodiments and features. Each mode of operation, each principle, each technical embodiment and each feature disclosed in the Fig. or in the text can be freely and arbitrarily combined with all claims, each feature in the text and in the other Fig., other modes of operation, principles, technical embodiments and features contained in this disclosure or resulting therefrom, so that all conceivable combinations can be assigned to the described method. This also includes combinations between all individual embodiments in the text, i.e. in each section of the description, in the claims and also combinations between different variants in the text, in the claims and in the Figs. Nor do the claims limit the disclosure and thus the possible combinations of all the features disclosed. All disclosed features are also explicitly disclosed here individually and in combination with all other features.

1. An inspection device for a layer material for the production of fuel or battery cells, wherein
a first layer conveyor is provided and arranged to receive a respective individual anode or cathode layer from a first transfer location and to bring the anode or cathode layer to a first delivery location;
a stacking table arranged to receive the respective individual anode or cathode layer at the first delivery location to form a layer stack;
the first layer conveyor is provided and arranged to deliver a respective individual anode or cathode layer at the first delivery location to the stacking table at the first delivery location; and
at least one image sensor is directed towards at least one region comprising an upper edge of the layer stack located on the stacking table in a side view, which region comprises a connection tab of the anode or cathode layer located uppermost on the layer stack, and is provided and set up for at least one image feed acquisition after the anode or cathode layer has been removed and the anode or cathode layer on the layer stack is deposited on the stacking table; and
a controller provided and arranged to indicate the usability of the layer stack in response to signaling based on processing of the at least one image feed acquisition.

2. The inspection device according to claim 1, wherein
the first layer conveyor comprises a layer turner which is provided and set up to pick up a respective individual anode or cathode layer by at least one pickup from the first transfer location and to rotate it the anode or cathode layer through a respective angle of rotation relative to the first delivery location.

3. The inspection device according to claim 1, wherein
the first layer conveyor comprises a layer gripper which is provided and set up to pick up a respective individual anode or cathode layer by a suction or gripping tool from the first transfer location and to bring the anode or cathode layer to the first delivery location.

4. The inspection device according to claim 1, wherein
a second layer conveyor is provided and arranged to receive a single cathode or anode layer and to bring the anode or cathode layer to a second delivery location; the stacking table includes at least one drive which is provided and arranged to move the stacking table back and forth between the first and the second delivery locations;
the first and second layer conveyors are each provided and arranged to deliver a single anode or cathode layer to the stacking table at the first and second delivery locations, respectively; and/or
the at least one drive is configured to align the respective layer conveyor and/or a respective layer turner or layer gripper relative to the stacking table as a function of a signaling based on processing of one or more image feed acquisitions in the controller.

5. The inspection device according to claim 4, wherein
the second layer conveyor comprises a layer turner which is provided and set up to pick up a respective individual anode or cathode layer by the at least one pickup from a second transfer location and to rotate it the anode or cathode layer by a respective rotation angle to the second delivery location.

6. The inspection device according to claim 4, wherein the second layer conveyor comprises a layer gripper which is provided and set up to pick up a respective individual anode or cathode layer by a suction or gripping tool from a second transfer location and to bring the anode or cathode layer to the second delivery location.

7. The inspection device according to claim 4, wherein
a first region and a second region of the layer stack each comprise a connection tab of the respective uppermost anode or cathode layer on the stacking table at the first and the second delivery locations, respectively; and/or
one or more image sensors are arranged on a first side of the inspection device, and/or
one or more image sensors are arranged on a second side of the inspection device; and/or
one or more image sensors are arranged in a fixed position relative to the stacking table; and/or
one or more image sensors are connected to the stacking table in order to be movable therewith.

8. The inspection device according to claim 1, wherein
the at least one image sensor is adjustable and/or movable in operation along its optical axis for focusing; and/or
a light source associated with the at least one image sensor is set up to illuminate the anode/cathode position for an image feed acquisition by the at least one image sensor; and/or
at least one optically effective element is associated with the at least one image sensor; wherein
the optically effective element is set up to make the connection tab of an anode or cathode layer located at the top of the layer stack recognizable in the at least one image feed acquisition after the anode or cathode layer has been deposited on the layer stack; and wherein
the at least one optically effective element is a lens or lens arrangement, a mirror or mirror arrangement, a prism or prism arrangement, an optical fiber arrangement, an area light, a coaxial ring illumination, a dark field illumination, a transmitted light illumination, or a combination thereof.

9. The inspection device according to claim 8, wherein
the transmitted light illumination is arranged on the opposite side of the at least one image sensor beyond the position of the connection tab on the stacking table, and is arranged to take the connection tab into the illumination in order to detect, by processing of the at least one image feed acquisition, a lift-off of the connection tab in which the uppermost edge of the connection tab is not oriented substantially horizontally (<±10°) in the image feed acquisition and/or causes an interfering contour.

10. The inspection device according to claim 8, wherein
the coaxial ring illumination is arranged on the side of the at least one image sensor, on this side of the position of the connection tab on the stacking table, and is arranged to take the connection tab into the illumination in order to detect, by processing of the at least one image feed acquisition, a lifting of the connection tab in which the uppermost edge of the connection tab in the image feed acquisition is not oriented essentially horizontally and/or causes an interfering contour.

11. An inspection method in the manufacture of modules or precursors of modules comprises the steps of:
picking up an individual anode or cathode layer at a transfer location and bringing the anode or cathode layer from the transfer location to a delivery location;
delivering the respective individual anode or cathode layer at the delivery location onto a stacking table to form a layer stack;
pointing an image sensor at a region comprising an upper edge of the layer stack located on the stacking table in a side view, wherein the region comprises a connection tab of the anode or cathode layer located uppermost on the layer stack; and wherein an image feed is performed by the image sensor after the anode or cathode layer has been deposited on the stacking table; and
indicating a usability of the layer stack depending on a signaling based on a processing of the image feed.

12. The inspection method according to claim 11, further comprising the steps of:
setting the image sensor to focus along its optical axis and/or moving the image sensor to focus along its optical axis in operation; and/or
illuminating the anode/cathode position for the image feed by the image sensor by a light source associated with the image sensor; and/or
assigning at least one optically effective element to the image sensor; wherein the optically effective element is intended and set up to make the connection tab of the anode or cathode layer located uppermost on the layer stack recognizable in the image feed in a side view after the anode or cathode layer has been deposited on the layer stack; and/or wherein
the at least one optically effective element is a lens or lens arrangement, a mirror or mirror arrangement, a prism or prism arrangement, an optical fiber arrangement, an area light, a coaxial ring illumination, a dark field illumination, a transmitted light illumination, or a combination thereof.

13. The inspection method according to claim 12, further comprising the steps of:
arranging the transmitted light illumination on the opposite side of the image sensor beyond the position of the connection tab on the stacking table,
to take the connection tab into the illumination;
to detect, by processing of the image feed, a lift-off of the connection tab in which the uppermost edge of the connection tab is not oriented horizontally and/or causes an interfering contour.

14. The inspection method according to claim 12, further comprising the steps of:
arranging the coaxial ring illumination on the side of the image sensor, this side of the position of the connection tab on the stacking table, and for
setting up to take the connection tab into the illumination;
detecting, by processing of the image feed, of a lift-off of the connection tab in which the uppermost edge of the connection tab in the image feed is not oriented horizontally and/or causes an interfering contour.
